(19) United States
(12) Patent Application Publication
(10) Pub. No.: US 2025/0091043 A1
(43) Pub. Date: Mar. 20, 2025

(54) METHODS FOR ANCHORING LYOPHILIZED REAGENTS TO A SUBSTRATE AND COMPLEXES FORMED THEREFROM

(71) Applicant: Argonaut Manufacturing Services, Inc., Carlsbad, CA (US)

(72) Inventor: Mark NOWAKOWSKI, Carlsbad, CA (US)

(73) Assignee: Argonaut Manufacturing Services, Inc., Carlsbad, CA (US)

(21) Appl. No.: 18/825,676

(22) Filed: Sep. 5, 2024

Related U.S. Application Data
(60) Provisional application No. 63/580,932, filed on Sep. 6, 2023.

(51) Int. Cl. B01L 3/00

(52) U.S. Cl. CPC B01L 3/502707; B01L 2200/12; B01L 2200/16; B01L 2300/0829; B01L 2300/161

(57) ABSTRACT

Described herein are methods for producing dried reagent: substrate complexes suitable for use in various types of assays. Specifically, the surface of the substrate can be modified such that subsequent lyophilization of the reagent on the substrate's surface can result in the dried reagent being anchored to the substrate's surface.

### CROSS-REFERENCE TO RELATED APPLICATIONS

This application claims the benefit of U.S. Provisional Application No. 63/580,932 filed Sep. 6, 2023, the entire contents of which are incorporated herein by reference.

### FIELD

The disclosure relates generally to lyophilized reagents, and more specifically to methods for anchoring a lyophilized reagent, or a combination of lyophilized reagents, to a substrate, as well as using this reagent: substrate complex to perform an assay.

### BACKGROUND

Numerous methods and systems have been developed for conducting chemical, biochemical, and/or biological assays. These methods and systems are essential in a variety of applications including medical diagnostics, food and beverage testing, environmental monitoring, manufacturing quality control, drug discovery, drug delivery and basic scientific research.

It can be desirable that assay methods and devices have one or more of the following characteristics: 1) high throughput; 2) high sensitivity; 3) high precision and/or accuracy; 4) low cost; 5) low consumption of reagents; 6) multiplexing capability; 7) stability of reagents; and 8) shippability at room temperature. It can also be desirable in many applications that these types of performance benefits are achieved with assay formats that are easy to carry out, are amenable to automation, use stable dry reagents, are efficient and less costly to manufacture, and/or require little or no manipulation before use.

### SUMMARY

Applicant has discovered methods of anchoring a dried reagent(s) on a substrate surface. Specifically, Applicant has discovered methods of generating dried reagent:substrate complexes that are capable of being produced in a scalable and/or automated process that can increase throughput of product as well as consistency and accuracy of assays using such dried reagent:substrate complexes.

In assays that employ microchannel or microcapillary architectures, conventional forms of lyophilized reagents, such as lyophilized reagent beads, may not be able to fit due to the small dimensions of the chambers and capillary paths. However, Applicant's dried reagent:substrate complexes can be accommodated in these microchannel or microcapillary architecture assays due to the size of the dried reagent anchored on the substrate.

Furthermore, conventional lyophilized beads shown in FIG. 12 or other conventional lyophilized forms typically have to be singulated before they can be handled with automatic equipment. These conventional lyophilized beads are very fragile and often break during the singulation process. In contrast to conventional lyophilized beads, the dried reagents described herein can be anchored on the substrate allowing case of automated handling without having to singulate the dried reagent products.

In some embodiments, a method includes: applying an adhesive layer to a side of a substrate; plasma treating a side of the substrate opposite the adhesive layer; depositing an aliquot of a liquid reagent on the plasma treated side of the substrate such that the contact angle of the liquid reagent and the plasma treated side of the substrate is less than 50 degrees; freezing the aliquot of the liquid reagent on the plasma treated side of the substrate; and lyophilizing the frozen aliquot of the reagent, thereby generating a dried reagent:substrate complex comprising a dried reagent anchored to the plasma treated side of the substrate and the adhesive layer on the side of the substrate opposite the dried reagent. In some embodiments, the plasma treating comprises atmospheric plasma treatment. In some embodiments, the atmospheric plasma treatment is at a rate of 5-15 mm/s. In some embodiments, the adhesive layer comprises a pressure sensitive adhesive, a UV curable adhesive, a cyanoacrylate adhesive, a polymer-based adhesives, or a thermally activated adhesive. In some embodiments, the method includes applying the adhesive layer to the substrate comprises laminating a pressure sensitive adhesive to the substrate. In some embodiments, the method includes cutting partially or entirely through the substrate in a predefined shape or pattern to define a reagent deposit zone on the substrate. In some embodiments, cutting partially or entirely through the substrate comprises laser, die, water jet, or plotter cutting. In some embodiments, the reagent deposit zone is attached to a portion of the substrate outside of the reagent deposit zone by one or more attachment points. In some embodiments, the reagent deposit zone is plasma treated. In some embodiments, the aliquot of liquid reagent is deposited on the reagent deposit zone. In some embodiments, the method includes removing the dried reagent:substrate complex from the portion of the substrate outside the reagent deposit zone. In some embodiments, removing the dried reagent:substrate complex comprises surrounding the dried reagent of the dried reagent:substrate complex with removal tool comprising a suction tip. In some embodiments, the suction tip attaches to a portion of the reagent deposit zone in a region between a perimeter of the reagent deposit zone and a perimeter of the dried reagent. In some embodiments, the removal tool does not contact the dried reagent during removal of the dried reagent:substrate complex. In some embodiments, the method includes adding the dried reagent:substrate complex to an assay device. In some embodiments, the method includes contacting the dried reagent:substrate complex with a test sample to produce a reaction mixture. In some embodiments, the method includes detecting a target analyte in the reaction mixture if the target analyte is present in the test sample. In some embodiments, the method includes depositing a second aliquot of a second liquid reagent on the frozen aliquot of the first liquid reagent. In some embodiments, the method includes freezing the second aliquot on the first frozen aliquot and lyophilizing the first and second frozen aliquots, thereby generating a dried reagent:substrate complex comprising a first dried reagent anchored to the plasma treated side of the substrate, an adhesive layer on the side of the substrate opposite the first dried reagent, and a second dried reagent on a side of the first dried reagent opposite the substrate. In some embodiments, the substrate has a thickness of about 0.001-0.01 inches. In some embodiments, the lyophilization step takes less than 1 hour. In some embodiments, the method includes adding micro-structures in and/or on the side of the substrate opposite the adhesive layer. In some embodiments, the micro-structures are formed by debossing, vacuum forming, injection molding, photolithography, or embossing. In some embodiments, the dried reagent has a maximum height and an outer diameter, wherein the maximum height is equal to or less than 50% of the outer diameter. In some embodiments, the dried reagent is anchored to the plasma treated side of the substrate such that it takes at least about 50 g of force to dislodge the dried reagent from the substrate as measured by sheer testing.

In some embodiments, dried reagent:substrate complexes can include a dried reagent species (i.e., a dried reagent having a defined chemical composition) disposed on a reagent deposit zone of a enhanced surface of a substrate. In some embodiments, the dried reagent can be formed from a known or measured volume (or volume equivalent (e.g., mass) of desired liquid reagent (i.e., a liquid reagent having a defined chemical composition, which definition can be the result of an extraction, separation, fractionation, combination, and/or addition of one or more components, for example, chemicals, etc.) deposited or otherwise disposed on a reagent deposit zone (i.e., some or all) of a enhanced surface of a substrate to form a reagent:substrate complex. In some embodiments, such liquid reagent volumes can range from about 5000 μl to less than about 0.000001 μl prior to drying or any range in between, with volumes of about 1000, 500, 250, 100, 50, 25, 20, 15, 10, 9, 8, 7, 6, 5, 4, 3, 2, 1, 0.1, 0.01, 0.001, 0.0001, 0.00001, or 0.000001 μl prior to drying. In some embodiments, drying or dehydration processes include lyophilization. In some embodiments, the substrates include flexible membranes or meshes, which flexible membranes or meshes include thin films or thin film meshes. In some embodiments, the substrate is formed from a polymer, for example, a plastic. In some embodiments, the substrate is formed from a flexible membrane or mesh that is soluble. In some embodiments, drying a reagent:substrate complex forms a dried reagent:substrate complex. In some embodiments, the dried reagent:substrate includes a dried reagent anchored to a surface of the substrate. In some embodiments, dried reagent:substrate complexes formed from different liquid reagents, different volumes of the same liquid reagent, and/or different substrates will be understood to constitute different dried reagent:substrate complexes or different dried reagent:substrate complex species.

In some embodiments, a dried reagent:substrate complex includes a dried reagent having a convex, concave, or flat upper surface and a substantially flat, flat, or smooth bottom surface. In some embodiments, the upper surface (e.g., the side of the dried reagent opposite the substrate) of the dried agent can be exposed to the environment, which can facilitate reconstitution of the dried reagent upon exposure to a sufficient volume of a desired solvent or solution (e.g., water, a buffer, a liquid biological sample or a processed derivative or fraction thereof, etc.). In some embodiments, the shape of the dried reagent's upper surface can be defined, at least in part, by the surface enhancement of the substrate upon which the liquid reagent was deposited prior to drying. Other factors that can influence the shape of the dried reagent's upper surface include the drying conditions employed to dry the reagent, whether the reagent deposit zone is bounded by or includes one or more structures, for example, a perimeter wall, one or more posts, etc. present on its surface, or combinations thereof. As will be appreciated, such additional structures can be included during the manufacture of the substrate. In some embodiments, the dried reagent's bottom surface (e.g., substantially flat bottom surface) can be typically defined by the top or upper (or other) surface of the substrate its attached/anchored to (e.g., reagent deposit zone of substrate).

The shape of the dried reagent of the dried reagent:substrate complex can have many advantages over the conventional lyophilized bead shapes. First, the dried reagent:substrate complexes disclosed here can be incorporated into devices that utilize microcapillary architecture. Most time the height of the internal features of these devices can be less than 1 mm. The diameter of a conventional lyophilized 5 microliter bead would be about 2.1 mm, whereas the height of a 5 microliter dried reagent:substrate complex disclosed herein can be on the order of about 0.5 mm, thereby allowing the dried reagent:substrate complex to accommodate microcapillary architecture devices. Second, current microcapillary devices utilize very small sample volumes and these small volumes dictate very small reaction reagent amounts. The use of a lyophilized reagent on a substrate can allow incorporation into the microcapillary device space. Third, the increased surface of the dried reagent:substrate complexes disclosed herein versus a lyophilized bead can reduce the reconstitution of the lyophilized reagent, resulting in a more homogenous solution. Fourth, lyophized beads with less than 5 uL volume are very difficult to handle from an automated assembly standpoint, whereas the dried reagent:substrate complexes disclosed herein can easily be handled via conventional microelectronics automation due to their predetermined location of the lyophilized reagent and due to being achored on the substrate. Fifth, the amount of time required to lyophilize a product is directly related to the thickness of the product (due to mass transfer) and the surface area in contact with the lyophilizer shelf (the larger suface area, the most efficient heat transfer). For example, a 2.1 mm diameter, 5 uL bead will take much longer to lyophilize that a 5 uL reagent:substrate complex due to reduced thickness of the product being lyophilized and the increased surface area in contact with the lyophilizer shelf of the product being lyophilized. Lastly, by incorporating an adhesive on the bottom of the substrate, the dried reagent:substrate complexes disclosed herein can be held in place. This can prevent damage or dislodging of the lyophilized reagent during shipping and handling. In contrast to the dried reagent:substrate complexes disclosed herein, lyophilized beads are difficult to anchor to a device. This can result in cracked lyophilized beads during shipping and handling and/or a portion of the lyophilized bead breaking off and traveling through the capillary channel to another area of the device, thus resulting in a reaction where a portion of the lypophilized reagent does not take part in the reaction.

In some embodiments, the surface of the reagent deposit zone upon which a liquid reagent is to be deposited can be flat, concave, convex, or otherwise patterned as desired. In some embodiments, such patterning can include one or more structures (i.e., micro-structures/features) such as posts, ridges, channels, and the like. These structures can be micro-sized.

In some embodiments, a dried reagent:substrate complex can be substantially disc-shaped when viewed from above, for example. In some embodiments, a dried reagent:substrate complex can be engineered to take any desired two-dimensional shape on the enhanced surface of a substrate. Such engineering includes, for example, providing one or more surface features onto or into the surface of the reagent deposit zone that interfaces with or contacts the liquid reagent when the liquid reagent is dispensed or deposited thereon. Representative two-dimensional shapes (e.g., when viewed from above) include, but are not limited to, those corresponding to polygons, e.g., triangles, rectangles, pentagons, hexagons, septagons, octagons, nonagons, decagons, crescents, ovals, ellipses, and combinations of any desired shape, particularly those that may be adapted for particular microfluidic assay devices or other architectures.

In some embodiments, the dried reagent component of a dried reagent:substrate complex has a height that is reduced as compared to what the height of the dried reagent component would have been if the surface of the substrate was not treated/enhanced. As disclosed herein, a “dried reagent component” refers to a one or more dried reagent species disposed on the substrate.

In some embodiments, the dried reagent component of a dried reagent:substrate complex can comprise a plurality (i.e., two or more) of different dried reagent species, which different dried reagent species can be layered one on top of another. In some embodiments, the dried reagent component of a dried reagent:substrate complex may comprise two or more layers of the same dried reagent species. Yet other embodiments with three or more layers, the dried reagent component can contain at least two layers of the same dried reagent species. In some embodiments, the dried reagent component of a dried reagent:substrate complex comprises at least 2, 3, 4, 5, 6, 7, 8, or more substantially homogeneous layers each comprised of a different reagent formulation.

When the dried reagent component includes two or more dried reagent species (preferably layered one on top of another), each reagent layer can be separated from the other reagent layer(s) by an intervening reagent separation layer. When multiple reagent separation layers are present in a dried reagent:substrate complex, each separation layer can be comprised of the same or different material or chemical composition.

In some embodiments, a dried reagent:substrate complex can be defined by a maximum height and/or a periphery dimension, for example, an approximated or substantially known length of an outer diameter or circumference. Advantageously, the maximum height of the dried reagent component of the complex is equal to or less than about 90, 80, 70, 60, 50, 40, 30, 20, or 10% of a periphery dimension such as the circumference dried reagent component of the dried reagent:substrate complex.

In some embodiments, the dried reagent component of the dried reagent:substrate complex can comprise a moisture content of less than about 10, 9, 8, 7, 6, 5, 4, 3, 2, or 1% by weight after drying, for example, by lyophilization.

In some embodiments, at least the reagent deposit zone(s) of the enhanced surface of the substrate is (are) treated to stabilize and/or anchor the dried reagent, wherein the treatment optionally is performed before or after deposition of a desired volume of a particular liquid reagent formulation. In some embodiments, without stabilization and/or anchoring of the dried reagent on the substrate, the dried reagent may be dislodged during subsequent handling.

In some embodiments, the reagent deposit zones on the substrate have defined positions in order to facilitate automated manufacture of large numbers of dried reagent:substrate complexes, e.g., 10-1,000,000 or more dried reagent:substrate complexes. As those in the art will appreciate, the number of dried reagent:substrate complexes produced can depend on such factors as whether the dried reagent:substrate complexes are produced in a continuous or batch manner, for example, by depositing a known volume of a particular desired liquid reagent at particular, preferably defined, locations (e.g., addresses defined by Cartesian (x and y) coordinates) on the enhanced surface of the substrate. In some embodiments, deposition of a known volume of the particular desired liquid reagent on the substrate defines the reagent deposit zone, while in other embodiments the location of one or more particular reagent deposit zones on the substrate can be defined prior to liquid reagent deposition, i.e., at an “address” on the enhanced surface of the substrate. In some embodiments, aliquots of different liquid reagent species can be concurrently (i.e., at the substantially the same time) dispensed onto different reagent deposit zones on the same substrate. In some embodiments, aliquots of the same or different liquid reagent species can be dispensed in series or in parallel (i.e., two or more aliquots being concurrently dispensed onto different reagent deposit zones or layered on top of a liquid reagent species that had previously been deposited on the reagent deposit zone located on the same or a different solid phase substrate to form a dried reagent:substrate complex having two or more layers of different reagent species, which reagent layers may be separated by intervening reagent separation layers).

In some embodiments, the reagent deposit zone has a periphery that is bounded by a perimeter region of the substrate wherein the perimeter region comprises one or more recessed portions, cut-outs, or kiss cuts that extend partially or entirely through the substrate so that the dried reagent:substrate complex can be detached or removed from the rest of the substrate. In some embodiments, the perimeter region has at least about 1, 2, 3, 4, 5, or more recessed portions, cut-outs, or kiss cuts that extend around at least about 50, 60, 70, 80, 90, 95%, or more, even completely (i.e., 100%), about the perimeter region.

In some embodiments, assay devices can include at least one dried reagent:substrate complex disclosed herein. In some embodiments, such an assay device is a microfluidic device, e.g., a lateral flow diagnostic device.

In some embodiments, a method includes: a) depositing a liquid aliquot of a reagent on a substrate having a surface for contacting the reagent, wherein the surface is treated to increase the hydrophilicity and/or anchoring of the dried reagent on the surface; and b) treating the surface under conditions to partially or entirely desiccate the aliquot, thereby generating the dried reagent:substrate complex on the substrate. In some embodiments, the formed reagent:substrate complex has a disc shape including a convex or concave top surface.

In some embodiments, a method includes: a) depositing a liquid aliquot of a reagent on a substrate having a surface for contacting the reagent, wherein the surface is treated to increase the hydrophilicity and/or anchoring of the dried reagent on the surface; and b) treating the surface under conditions to partially or entirely desiccate the aliquot and form a solid phase disc, thereby generating the dried reagent:substrate complex on the substrate. In some embodiments, the formed reagent:substrate complex has a convex or concave top surface.

In some embodiments, a method includes: a) depositing a first liquid aliquot of a first reagent on a substrate having a surface for contacting the reagent, wherein the surface is treated to increase the hydrophilicity of the surface; b) freezing the first aliquot forming a first homogeneous frozen layer of the first reagent; c) depositing a second liquid aliquot of a second reagent on the first homogeneous frozen layer; d) freezing the second aliquot forming a laminate having the first homogeneous frozen layer and a second homogeneous frozen layer of the second reagent; and e) treating the surface under conditions to lyophilize the laminate, thereby generating the dried (hybrid) reagent:substrate complex on the substrate. In some embodiments, a dried reagent:substrate complex can be produced by the methods disclosed herein. In some embodiments, an assay device for conducting a biological or chemical assay can include a dried reagent:substrate complex described herein.

In some embodiments, a method of performing an assay utilizing a dried reagent:substrate complex includes contacting the dried reagent:substrate complex whether alone or disposed in an assay device, with a test sample to produce a reaction mixture, and detecting an analyte in the reaction mixture.

It will be appreciated that any of the variations, embodiments, examples, aspects, features and options described in view of the methods apply equally to the systems, reagent:substrate complexes, reagents, substrates, assays, devices, other methods, and vice versa. It will also be clear that any one or more of the above variations, embodiments, examples, aspects, features and options can be combined.

Additional advantages will be readily apparent to those skilled in the art from the following detailed description. The aspects and descriptions herein are to be regarded as illustrative in nature and not restrictive.

All publications, including patent documents, scientific articles and databases, referred to in this application are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

### BRIEF DESCRIPTION OF THE FIGURES

In the drawings, like elements are assigned like reference numerals. The drawings are not necessarily to scale, with the emphasis instead placed upon the principles of the disclosed herein. Additionally, each of the embodiments depicted are but one of a number of possible arrangements utilizing the fundamental concepts of the disclosure. The drawings are briefly described as follows:

FIG. 1 is a top view of a substrate having a plurality of reagent deposit zones in accordance with some embodiments disclosed herein.

FIG. 2 is a partial exploded view of a substrate having dried reagent:substrate complexes formed on reagent deposit zones in accordance with some embodiments disclosed herein.

FIG. 3 is a top view of an assay device including a substrate having a dried reagent:substrate complex formed on its surface in accordance with some embodiments disclosed herein.

FIG. 4 is an elevated side view of the assay device shown in FIG. 3 in accordance with some embodiments disclosed herein.

FIG. 5 illustrates a lateral flow device including at least one dried reagent:substrate complex in accordance with some embodiments disclosed herein.

FIG. 6A is a top view image of four dried reagent:substrate complexes in accordance with some embodiments disclosed herein.

FIG. 6B is a side view image of a dried reagent:substrate complex in accordance with some embodiments disclosed herein.

FIG. 7A is a bar chart of the Ct values for the CDC 2019-nCoV RT-PCR N1 resulting from experiments described in Example 2 using reagent:substrate complexes in accordance with some embodiments disclosed herein.

FIG. 7B is a bar chart of the Ct values for the CDC 2019-nCoV RT-PCR N2 resulting from experiments described in Example 2 using reagent:substrate complexes in accordance with some embodiments disclosed herein.

FIG. 7C bar chart of the Ct values for the RNase P template at a constant copy number with variable amounts of SARS-CoV-2 RNA resulting from experiments described in Example 2 using reagent:substrate complexes in accordance with some embodiments disclosed herein.

FIG. 7D is an amplification curve for the CDC 2019-nCoV RT-PCR N1 resulting from experiments described in Example 2 using reagent:substrate complexes in accordance with some embodiments disclosed herein.

FIG. 7E is an amplification curve for the CDC 2019-nCoV RT-PCR RNase P resulting from experiments described in Example 2 using reagent:substrate complexes in accordance with some embodiments disclosed herein.

FIG. 7F is an amplification curve for the CDC 2019-nCoV RT-PCR resulting from experiments described in Example 2 using reagent:substrate complexes in accordance with some embodiments disclosed herein.

FIG. 8 shows tabular data of the RT-qPCR results corresponding to the results from the experiments depicted in FIGS. 7A-F for the CDC 2019-nCoV RT-PCR assay for reagent:substrate material compared to the non-lyophilized liquid reagents in accordance with some embodiments disclosed herein. Each condition was run in triplicate and contained SARS-CoV-2 RNA and RNase P template as indicated.

FIG. 9A illustrates a device described in Example 2 that contains two dried reagent:substrate complexes before the addition of liquid in accordance with some embodiments disclosed herein.

FIG. 9B illustrates a device of FIG. 9A after the addition of water to the device in accordance with some embodiments disclosed herein.

FIG. 10A illustrates an image of an air tweezer handling a dried reagent:substrate complex in accordance with some embodiments disclosed herein.

FIG. 10B illustrates an image of dried reagent:substrate complexes with an air tweezer for handling in accordance with some embodiments disclosed herein.

FIG. 11 illustrates an image of dried reagent:substrate complexes configured in strips to illustrate a representative example of a lyophilized reagent configuration compatible with manufacturing automation in accordance with some embodiments disclosed herein.

FIG. 12 is a photograph of conventional lyophilized beads.

FIG. 13A is a side view of a substrate with a micro-feature/structure in the surface of the substrate in accordance with some embodiments disclosed herein.

FIG. 13B is a side view of a substrate with a micro-feature/structure on the surface of the substrate in accordance with some embodiments disclosed herein.

FIG. 14A is an example of a substrate surface with a high contact angle in accordance with some embodiments disclosed herein.

FIG. 14B is an example of a substrate surface with a low contact angle in accordance with some embodiments disclosed herein.

FIG. 15 is a photograph of a dried reagent:substrate complex in accordance with some embodiments disclosed herein.

FIG. 16 is a photograph of an example setup for determining if the dried reagent(s) is anchored to the surface of the substrate using sheer testing in accordance with some embodiments disclosed herein.

FIG. 17A illustrates an example of a cross-sectional side view of the removal of a dried reagent:substrate complex in accordance with some embodiments disclosed herein.

FIG. 17B illustrates an example of a cross-sectional top view of the removal of a dried reagent:substrate complex in accordance with some embodiments disclosed herein.

FIG. 17C illustrates an example of a second cross-sectional top view of the removal of a dried reagent:substrate complex in accordance with some embodiments disclosed herein.

### DETAILED DESCRIPTION

Disclosed herein are methods for forming a dried reagent anchored on a substrate (i.e., a dried reagent:substrate complex) in an automated, scalable workflow. As stated above, conventional lyophilized beads typically are singulated before they can be handled with automated equipment. These lyophilized beads are very fragile and often break during the singulation process. In contrast, the methods disclosed herein can anchor the dried reagent on the substrate allowing ease of automated handling without requiring singulation of the dried product. In some embodiments, the dried reagents can be anchored to the substrate in a predetermined orientation such as a cartesian coordinate system in order to facilitate automated handling.

Multiple methods can be utilized to determine if the dried (e.g., lyophilized) reagent(s) is anchored to the surface of the substrate. In some embodiments, the dried (e.g., lyophilized reagent(s) can be considered anchored to the surface of the substrate according to the following test: The substrate with the dried (e.g., lyophilized) reagent(s) (e.g., the dried reagent:substrate complex) can be placed on an orbital shaker (e.g., Elmi Sky Line Analog Orbital Shaker), the orbital shaker can be set to table speed 2, and the time is recorded until the dried (e.g., lyophilized) reagent(s) dislodges from the surface of the substrate. The dried reagent(s) can be said to be anchored to the surface of the substrate if it did not dislodge from the surface of the substrate within one minute of being on the orbital shaker.

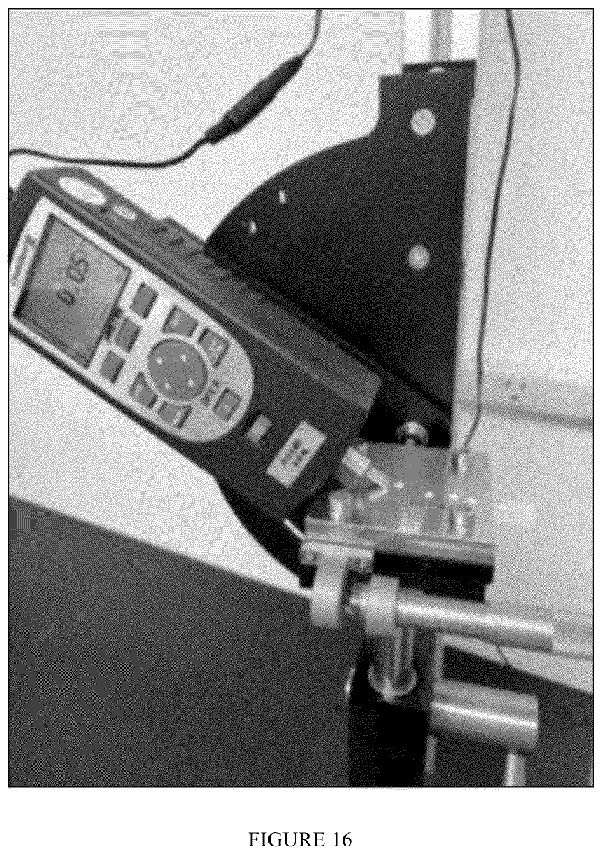

In some embodiments, the dried (e.g., lyophilized) reagent(s) can be considered anchored to the surface of the substrate according to the following test: The substrate with the dried (e.g., lyophilized) reagent(s) (e.g., the dried reagent:substrate complex) can be placed on a test setup for a sheer test using a Chatillon DFS II Digital Force Gauge and the force is measured that is required to dislodge the dried reagent(s) from the surface of the substrate. The dried reagent(s) can be said to be anchored to the surface of the substrate if it did not dislodge from the surface of the substrate until at least about 50 g, at least about 60 g, at least about 70 g, at least about 80 g, or at least about 90 g of force. An example of a setup for determining if the dried reagent(s) is anchored to the surface of the substrate using a sheer test is shown in FIG. 16.

In addition, lyophilizing a reagent in-situ in an assay device may be impractical as this can require substantially more shelf space in the lyophilizer and/or result in much longer lyophilization process times due to inefficient heat transfer. As such, Applicant has discovered a method to mass produce dried reagent:substrate complexes that can easily be incorporated into a wide variety of assay type devices.

In some embodiments, the methods described herein can allow for formation of one or more dried reagent:substrate complexes on the surface of a substrate where the reagent is deposited on a reagent deposit zone on the surface in a small volume of fluid and treated under conditions that result in desiccation of the liquid reagent and formation of a dried solid reagent. In some embodiments, treatment of the surface of the substrate to increase hydrophilicity and/or anchoring of the dried reagent can allow formation of a dried reagent having a reduced height dimension as opposed to a spherical bead shape having a uniform diameter similar to that of conventional lyophilized beads. Many in-vitro diagnostic applications utilize cartridges with microfluidic dimensions which may not accommodate lyophilized beads with a diameter greater than 1 mm. The methods disclosed herein can allow for generation of solid, dried reagent:substrate complexes that have a reduced height dimension making them suitable for use in applications that may not accommodate reagent beads. Specifically, treating the surface of the substrate to increase hydrophilicity and/or anchoring of the dried reagent of the surface before a liquid reagent is deposited on the surface can vastly decrease the time required to treat the liquid reagent to desiccate the liquid and transform it to a dried and stable solid, as well as allowing generation of dried reagent:substrate complexes that include homogeneous layers of different reagents in a single reagent deposit zone.

In some embodiments, before lyophilization of the liquid, the liquid reagent can be frozen. For example, the liquid reagent on the substrate can be placed on a lyophilizer shelf that has been precooled to a temperature of less than 0° C. In some embodiments, once the liquid reagent is frozen, the lyophilization cycle can be started. The amount of time required to lyophilize a product can be directly related to the thickness of the product (due to mass transfer) and the surface area in contact with the lyophilizer shelf. The larger surface area in contact with the lyophilizer shelf, the more efficient the heat transfer. For example, a 2.1 mm diameter, 5 microliter bead can take much longer to lyophilize than a 5 microliter reagent disclosed herein due to reduced thickness of the product being lyophilized and/or the increased surface area in contact with the lyophilizer shelf of the product being lyophilized.

As stated above, the surface of the substrate that will receive the liquid reagent can be treated to increase the hydrophilicity of the surface and/or ability of the surface to anchor the dried reagent. Those familiar with the art of modification of surface (e.g., polymer surfaces) which can form the substrate will appreciate that varying degrees of surface modification will results in varying degrees of surface energy and consequently varying degrees of hydrophilicity and/or potential anchor ability for a dried reagent. If the surface of the substrate before receiving the liquid reagent to be dried is not modified in any way, the dried reagent after treatment, such as lyophilization, may be easily removed from the substrate. In other words, the dried reagent (e.g., lyophilized reagent) is not anchored to the substrate. In some embodiments, if the substrate is modified to be rendered hydrophilic and/or modified to increase its ability to anchor a dried reagent, the dried reagent after lyophilization can become anchored to the substrate and may not easily be removed from the reagent deposit zone of the substrate. However, simply rendering a surface of the substrate hydrophilic by adding a surfactant may not result in a sufficiently anchored lyophilized product. For example, if a substrate is coated with a surfactant, the lyophilized product may easily be dislodged from the substrate during future handling.

In some embodiments, the substrate thickness is very small, allowing the lyophilized dried reagent:substrate complex to be easily accommodated in an assay device, such as a microchannel assay device. In some embodiments, the nature of anchoring the lyophilized dried reagent to the substrate can result in a dried reagent component that is much easier to handle in an automated assembly process due to the robust nature of the two-piece component (i.e., the dried reagent and substrate components of the dried reagent:substrate complex).

In some embodiments, a dried reagent:substrate complex produced by the methods disclosed herein may not warrant any further manipulation before use to perform an assay, may be less costly and more efficient to produce, and/or may results in a simplified user workflow. As stated above, conventional lyophilized beads required singulation. In addition, expensive specialty equipment is typically used to handle these conventional lyophilized beads (e.g., a vacuum end effector) and often damage the lyophilized beads. In contrast to conventional lyophilized beads, the dried reagent:substrate complexes disclosed herein can be handled with standard off-the-shelf automated pick and place equipment, thereby reducing overall cost and increasing efficiency.

In some embodiments, a dried reagent:substrate complex produced by the methods disclosed herein may be incorporated into a stand-alone assay device, such as a lateral flow device, or used directly by the end user to conduct a single type of assay or multiple types of assays (without the need to add additional reagents), thereby increasing reliability of a respective assay result and/or reducing inconsistencies due to lot-to-lot variation in reagents.

As stated above, disclosed herein are methods of generating a dried reagent component on a substrate, thereby anchoring the dried reagent to the substrate surface. The dried reagent:substrate complex may be used in a variety of applications, such as biological and chemical assays, as well as in-vitro diagnostics and therapeutics.

In some embodiments, the methods disclosed herein include depositing a liquid aliquot of a desired reagent on a (solid phase) substrate having a surface for contacting the reagent, wherein the surface has been treated to increase the hydrophilicity and/or ability to anchor the dried reagent; and b) treating the liquid reagent on the surface of the reagent deposit zone under conditions to at least partially desiccate the aliquot and form a solid, wherein the increased hydrophilicity of the surface causes the liquid reagent to form a shape having a reduced height dimension as compared to the height that would have resulted from the process had the surface not been treated to enhance its hydrophilicity and/or anchoring potential, thereby generating the dried reagent:substrate complex. In some embodiments, the increased hydrophilicity of the surface causes the dried reagent to be anchored to the surface of the substrate.

In some embodiments, a liquid aliquot of a reagent deposited on the surface of the substrate can be treated under conditions to desiccate the aliquot and form a stable dried solid. In some embodiments, treating can include one or more of lyophilization, increased temperature, or decreased pressure. However, it will be understood that any conventional method known to reduce the solvent content of a liquid may be utilized. In some embodiments, desiccation (i.e., lyophilization) can produce a stable dried reagent on the surface of the substrate that has a residual moisture content of less than about 10, 9, 8, 7, 6, 5, 4, 3, 2 or 1% by weight. In some embodiments, desiccation (i.e., lyophilization) can produce a stable dried reagent on the surface of the substrate that has a residual moisture content of more than about 0.001, 0.01, 0.1, 0.5, 1, or 2% by weight. In some embodiments, the residual moisture content of the dried reagent can aid in the shelf life of the dried reagent, help maintain the physical integrity of the dried reagent during handling and/or shipping, and/or aid in the optimization of the dissolution time when the dried reagent is used (for example in an assay). In some embodiments, the residual moisture content of the lyophilized material (e.g., the reagent) can be measured using a Mettler Toledo C20SD Coulometric Karl Fisher titrator.

As used herein, “lyophilization” is the removal of solvent from the frozen state by sublimation. In some embodiments, lyophilization can be accomplished by freezing the solution below its melting point and then manipulating the temperature and pressure to provide sublimation. Precise control of temperature and pressure can permit drying from the frozen state without product melt-back. In practical applications, the process can be accelerated and more precisely controlled under reduced pressure conditions.

As used herein, “lyophilizate” is the solid, powder, or granular material remaining after lyophilization. In some embodiments, the solid, powder or granular material can be essentially free of solvent.

In some embodiments, desiccation can be achieved by lyophilization. In some embodiments, the reagents deposited on the surface can be treated under lyophilization conditions for less than about 25, 24, 23, 22, 21, 20, 19, 18, 17, 16, 15, 14, 13, 12, 11, 10, 9, 8, 7, 6, 5, 4, 3, 2, or 1 hour to form a dried reagent:substrate complex. In some embodiments, the reagents deposited on the surface can be treated under lyophilization conditions for more than about 1 minute, 5 minutes, 10 minutes, 15 minutes, 20 minutes, 25 minutes, 30 minutes, or 45 minutes to form a dried reagent:substrate complex. In some embodiments, the lyophilization time required to form the dried reagent:substrate complex is reduced and in some cases significantly reduced as compared to the lyophilization time required to form the dried reagent:substrate complex on an untreated surface. For example, it typically requires approximately 24 hours to lyophilize a 5 microliter bead on an untreated surface, whereas it may only require approximately one hour to lyophilize a 5 microliter reagent on a hydrophilically treated surface, as disclosed herein, due to the product thickness and/or surface of the area in contact with the lyophilizer shelf. In some embodiments, the lyophilization time is reduced by greater than about 10, 20, 30, 40, 50, 60, 70, 80, 85, 90 or 95% as compared to the lyophilization time required to form the dried reagent:substrate complex on an untreated surface.

In some embodiments, the (e.g., solid phase) substrate includes a surface for receiving a liquid reagent that is treated to increase the amount of hydrophilicity, functionalization, and/or ability to anchor a dried regent of the surface. In some embodiments, the intended deposition locations for liquid reagent aliquots on the surface of the solid phase substrate can be referred to as “reagent deposit zones”. In some embodiments, treating the substrate's surface, particularly in the regions intended as reagent deposit zones, can allow a liquid reagent droplet deposited on the surface to spread across the surface and produce a shape having a reduced height, such as a disc, as compared to a more hemispherically shaped liquid reagent droplet that would form had the surface not been treated to enhance or increase its hydrophilicity, functionalization, and/or ability to anchor a dried regent.

However, not all surface treatment/modification techniques that enhance hydrophilicity of the substrate surface may lead to the dried reagent being anchored to the substrate surface. Applicant discovered that simply rendering a surface of the substrate hydrophilic by adding a surfactant may not result in a sufficiently anchored dried reagent product. For example, Applicant added a 0.1% solution of Triton X-100 to a 0.003″ thick PET film and allowed the surfactant to dry on the PET film. A 5 microliter drop of a test reagent solution was added to the surfactant treated film and lyophilized. After lyophilization, the film containing the lyophilized product was removed from the lyophilizer and inverted. Upon inversion, the lyophilized product immediately dislodged form the PET film and fell off. In some embodiments, treating the surface of the substrate to increase, enhance, and/or improve hydrophilicity (and/or future anchoring of dried reagent) does not include adding or coating the surface of the substrate with a surfactant.

In some embodiments, treating the surface of the substrate to increase, enhance, and/or improve hydrophilicity of the substrate surface and/or anchoring a dried reagent to the substrate surface can include plasma treatment of the surface. In some embodiments, the plasma treatment can be atmospheric plasma treatment or a non-atmospheric plasma treatment. In some embodiments, the plasma treatment can be a vacuum plasma treatment (e.g., with oxygen). In some embodiments, plasma treatment (as described, for example, in Atmospheric Pressure Plasma Surface Treatment of Polymers and Influence on Cell Cultivation by Sasmazel et al, Molecules 2021 (26(6) which is herein incorporated by reference in its entirety) can modify the surface of the substrate such that it leaves free radicals on the surface of the substrate, thereby allowing bonding of the lyophilized materials. The use of plasma to modify the substrate surface can include the control of various parameters during the plasma treatment process to effectively result in a treated surface that will properly anchor a lyophilized reagent. In some embodiments, the plasma treatment can be conducted by a hand-held atmospheric plasma wand such as one made by Plasma Etch, Inc., for example. In some embodiments, the plasma wand can be used in the nearfield or far field module (with setting of “no process tools”). In some embodiments, the power of the plasma device can be set to about 50-100%, about 60-100%, about 70-100%, about 80-100%, about 85-95%, or about 90%. In some embodiments, the tip of the plasma device (e.g., tip of nearfield module) can be held approximately about 0.1-20 mm, about 0.5-10 mm, about 1-5 mm, or about 2 mm away from the substrate surface. In some embodiments, during plasma treatment, the width of the plasma treatment from the plasma device can be about 1-50 mm, about 5-40 mm, about 10-30 mm, about 15-25 mm, or about 20 mm. In some embodiments, during plasma treatment, the rate of plasma treatment can be about 1-50 mm/s, about 1-20 mm/s, about 5-15 mm/s, about 9-11, or about 10 mm/s.

In some embodiments, treating the surface of the substrate to increase, enhance, and/or improve hydrophilicity of the substrate surface and/or anchoring a dried reagent to the substrate surface can include the use of wet or dry etching techniques to smooth (or roughen) surfaces (e.g., silicon surface), adsorption and/or grafting of polyethylene oxide or other polymer layers to substrate surfaces to render them more hydrophilic and less prone to non-specific adsorption of biomolecules and cells, and/or the use of silane reactions to graft chemically-reactive functional groups to otherwise inert surfaces (e.g., silicon surface).

In some embodiments, treating the surface of the substrate to increase, enhance, and/or improve hydrophilicity of the substrate surface and/or anchoring a dried reagent to the substrate surface can include casting of discrete zones on a substrate with porous materials. In some embodiments, the porous materials can include nitrocellulose, polypropylene, or combinations thereof.

In some embodiments, treating the surface of the substrate to increase, enhance, and/or improve hydrophilicity of the substrate surface and/or anchoring a dried reagent to the substrate surface can include corona discharge treating the surface of the substrate, chemical vapor deposition (CVD) on the surface of the substrate, other chemical modifications of the surface of the substrate, or combinations thereof. In some embodiments, treating the surface of the substrate to increase, enhance, and/or improve hydrophilicity of the substrate surface and/or anchoring a dried reagent to the substrate surface can include coating the surface of the substrate with a sugar and/or a protein. In some embodiments, the sugar can include dextran-40, trehalose, or combinations thereof. In some embodiments, the protein can include bovine serum albumin (BSA).

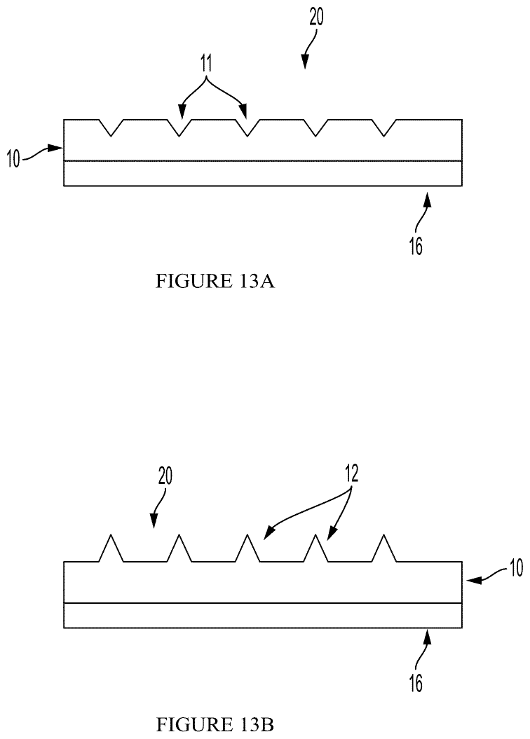

In some embodiments, treating the surface of the substrate to increase, enhance, and/or improve anchoring a dried reagent to the substrate surface can include adding micro-structures/features in and/or on the substrate surface. In some embodiments, these micro-features can be formed by debossing, vacuum forming, injection molding, photolithography, embossing, material deposition processing, or combinations thereof. In some embodiments, these micro-structures/features can take any shape on and/or in the substrate surface. For example, the shapes can be square, circular, rectangular, pyramidal, conical, posts, channels, and/or any other geometric shape. In some embodiments, the micro-structures/features can be shapes etched 11 into the substrate surface such as those shown in FIGS. 13 and/or the micro-structures/features can be shapes 12 made of various material (e.g., the material of the substrate for example) added or deposited on the surface of the substrate such as those shown in FIG. 13B.

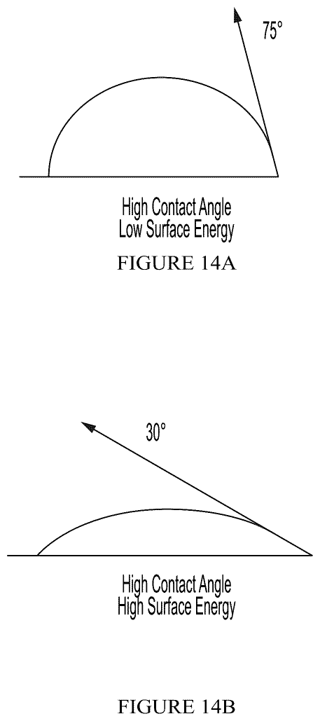

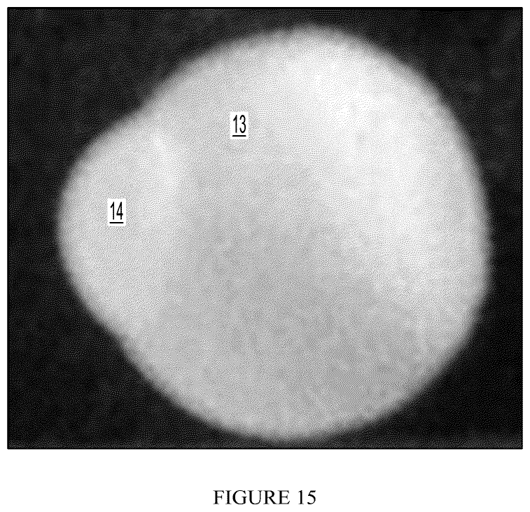

With regard to enhancing the hydrophilicity and/or anchoring potential of a substrate's surface, the surface may be treated to reduce the contact angle of a liquid reagent and thus dried reagent on the surface to about 75 degrees or less. The contact angle can be directly related to the surface energy of the substrate as shown in FIGS. 14A and 14B in that a low surface energy substrate will have a high contact angle and a high surface energy substrate will have a low contact angle. For example, if one were to add a 5 microliter drop of DI water to an untreated PET film, the drop would bead up and have a contact angle between about 75-90 degrees, meaning the film surface is fairly hydrophobic. In a similar manner, if the same PET film was treated with atmospheric plasma, the contact angle may be less than 30 degrees. In some embodiments, the surface is treated such that that the contact angle of the liquid reagent and/or dried reagent on the surface is less than about 75, 70, 65, 60, 55, 50, 45, 40, 35, 30, 25, 20, 15, or 10 degrees (and greater than 0 degrees). In some embodiments, the contact angle of the reagent on the substrate surface can be measured with an instrument called a goniometer.

In addition to treating a substrate's surface to increase, enhance, and/or improve hydrophilicity of the substrate surface and/or anchoring a dried reagent to the substrate surface, the substrate's surface may be functionalized. A surface may be referred to as “functionalized” when it includes a linker, a scaffold, a building block, or other reactive moiety attached thereto, whereas a surface may be “nonfunctionalized” when it lacks such a reactive moiety attached thereto. In some embodiments, treating the surface of the substrate to increase, enhance, and/or improve hydrophilicity of the substrate surface and/or anchoring a dried reagent to the substrate surface (as described above) may also simultaneously functionalize the surface of the substrate. In some embodiments, functionalizing the substrate may be in addition to treating the surface of the substrate to increase, enhance, and/or improve hydrophilicity of the substrate surface and/or anchoring a dried reagent to the substrate surface (as described above).

In some embodiments, a functionalized surface may refer to the surface of the substrate comprising a functional group. In some embodiments, a functional group may be a group capable of forming an attachment with another functional group. For example, a functional group may be biotin, which may form an attachment with streptavidin, another functional group. Exemplary functional groups may include, but are not limited to, aldehydes, ketones, carboxy groups, amino groups, biotin, streptavidin, nucleic acids, small molecules (e.g., for click chemistry), homo- and hetero-bifunctional reagents (e.g., N-succinimidyl (4-iodoacetyl) aminobenzoate (STAB), dimaleimide, dithio-bis-nitrobenzoic acid (DTNB), N-succinimidyl-S-acetyl-thioacetate (SATA), N-succinimidyl-3-(2-pyridyldithio) propionate (SPDP), succinimidyl 4-(N-mafeimidomethyl)-cyclohexane-1-carboxylate (SMCC) and 6-hydrazinonicotimide (HYNIC), and antibodies. In some instances, the functional group is a carboxy group (e.g., COOH). Additionally, photodeprotection techniques can be used to selectively activate chemically-reactive functional groups at specific locations of the surface, for example, the selective addition or activation of chemically-reactive functional groups such as primary amines or carboxyl groups on the surface may be used to covalently couple oligonucleotide probes, peptides, proteins, or other biomolecules to the surface. In some embodiments, the choice of surface treatment or surface modification utilized can depend both on the type of surface property that is desired and on the type of material from which the substrate is made.

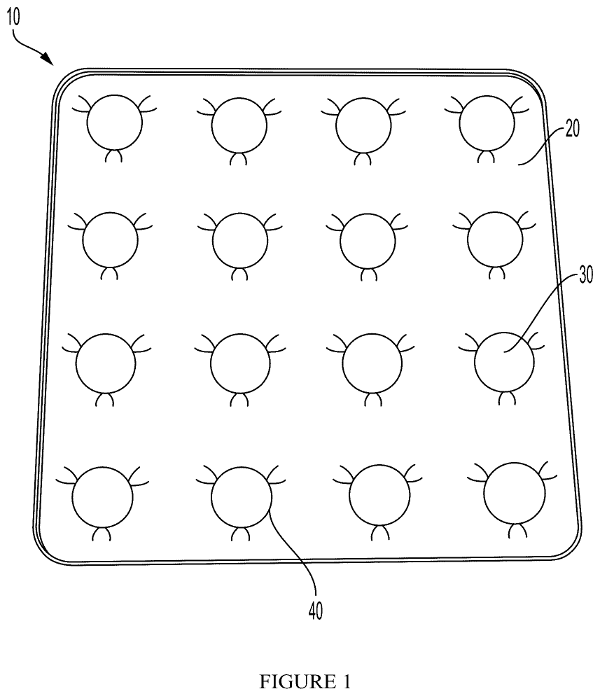

FIG. 1 shows a thin planar substrate utilized in the method in accordance with some embodiments disclosed herein. In some embodiments, the substrate 10 includes a top surface 20 which is treated to increase the hydrophilicity and/or anchoring a dried reagent to the substrate surface, thereby making it more suitable for receiving an aliquot of a liquid reagent. In some embodiments, as shown in FIG. 1, the substrate 10 can include one or more reagent deposit zones 30 upon which the liquid reagent can be deposited. In some embodiments, a or each reagent deposit zone 30 can be defined by a perimeter that includes one or more recessed regions, cut-outs, or kiss cuts 40 extending partially or entirely through the substrate 10 such that the reagent deposit zone 30 and dried reagent forming a dried reagent:substrate complex thereon may be detached from the rest of the substrate 10.

In some embodiments, it may be desirable to have the substrate containing the lyophilized reagent/product precut (i.e., recessed regions, cut-out, or kiss cut created) (with attachment points (e.g., tabs)) to each dried reagent:substrate complex to allow for case of automated handling, for example. In some embodiments, the recessed regions, cut-outs, or kiss cuts 40 may be formed in the substrate by a variety of techniques known in the art. For example, the recessed regions, cut-outs, or kiss cuts may be formed by laser cutting, die cutting, water jet cutting, plotter cutting, etching and the like, or combinations thereof. In some embodiments, the substrate can be precut prior to any reagent being added to the substrate. In some embodiments, precutting the substrate can define the reagent deposit zones on the substrate. In some embodiments, the substrate can be precut after the adhesive layer has been applied to a side of the substrate. In some embodiments, a or each reagent deposit zone can be defined by a perimeter that includes one or more recessed regions, cut-outs, or kiss cuts extending partially or entirely through the substrate and the adhesive layer. In some embodiments, the substrate (and adhesive layer) can be cut to a predefined shape to define the reagent deposit zones after the adhesive layer has been attached to a side of the substrate.

As shown in FIG. 1, each reagent deposit zone 30 is circular and has a recessed region, cut-outs, or kiss cuts 40 extending partially or entirely through the substrate 10. Each reagent deposit zone 30 in FIG. 1 is shown attached at three attachment points that can easily be broken by manual or automatic manipulation (for example) to separate a formed dried reagent:substrate complex from the rest of substrate 10 for use. However, it will be understood that the reagent deposit zone 30 may have any shape perimeter, e.g., square, triangular, elliptical, and the like, and include any number of recessed regions, cut-outs, or kiss cuts and/or attachment points to facilitate detachment of the reagent deposit zone from the substrate 10.

As discussed herein, the method can includes depositing a liquid aliquot of a reagent on the surface 20 of a substrate 10. In some embodiments, the method utilizes small volumes of liquid reagent thereby reducing cost of manufacture. In some embodiments, the amount of liquid reagent deposited in each aliquot is equal to or less than about 5000, 1000, 500, 250, 100, 50, 25, 20, 15, 10, 9, 8, 7, 6, 5, 4, 3, 2, 1, 0.1, 0.01, 0.001, 0.0001, 0.00001, or 0.000001 μl. In some embodiments, the amount of liquid reagent deposited in each aliquot is equal to or more than about 0.000001, 0.00001, 0.0001, 0.001, 0.01, 0.1, or 1 μl.

In some embodiments, the substrate 10 may be composed of a variety of materials and may be flexible, semi-flexible, or rigid. In some embodiments, suitable materials for the substrate can include, glass, ceramics, metals, plastics, polymers, and combinations thereof. In some embodiments, the material can be a solid sheet, film, or mesh. In some embodiments, the materials for construction of the substrate include non-polymeric and polymeric materials. In some embodiments, one or more of the following, non-limiting examples of materials may be used in construction of the substrate, including plastics (e.g., cyclic olefin copolymer (COC), cyclic olefin polymer (COP), polyethylene terephthalate (PET), polyethylene (PE), high-density polyethylene (HDPE), low-density polyethylene (LDPE), polyvinyl chloride (PVC), polypropylene (PP), polystyrene (PS), high impact polystyrene (HIPS), polyamides (PA), acrylonitrile butadiene styrene (ABS), polyethylene/acrylonitrile butadiene styrene (PE/ABS), polycarbonate (PC), polycarbonate/acrylonitrile butadiene styrene (PC/ABS), polymethylmethacrylate (PMMA)), metals, elastomers (e.g., polydimethylsiloxane (PDMS)), glass (e.g., borosilicate), ceramics, and composite materials, such as carbon fiber composites, or combinations thereof.

In some embodiments, the thickness of the substrate can be about at least about 0.00001, 0.0001, 0.0005, 0.001, 0.003, 0.005, or 0.01 inches. In some embodiments, the thickness of the substrate can be at most 1, 0.5, 0.1, 0.01, 0.005, 0.003, or 0.001 inches. As described, the substrate can be a solid, film, or mesh (i.e., a material comprised of a network of fibers, threads, or wires). In some embodiments that utilize solid or film substrates, the substrate can be machined, processed, or otherwise treated to introduce holes or pores in the substrate. Such holes or pores can be of any desired shape, for example, substantially cylindrical, and can be evenly or randomly spaced. Holes or pores can be introduced by any suitable method, including punching, stamping, machining, or laser cutting. In some embodiments, processing to introduce holes or pores can be introduced before or after treatment to enhance surface hydrophilicity and/or anchoring of the dried reagent. In some embodiments, hole or pore size ranges from about 0.001 mm to about 5 mm (or any range within this range), with holes or pores having a diameter ranging from about 0. 01 mm to about 4 mm being particularly advantageous. Examples or particular hole or pore diameters include about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.5, 2.0, 2.5, 3.0, 3.5, and 4.0 mm, as well as any diameter size or size range between any of these values. In the embodiments that employ mesh substrates, the mesh can be formed from any suitable material (or combination of different materials), for example, metals, plastics, fibers, or other flexible or ductile materials. As with solid substrates that have holes or pores, the openings in meshes suitable for use can be of any suitable size, including from about 0.001 mm to about 5 mm (or any range within this range), with opening sizes ranging from about 0. 01 mm to about 4 mm being particularly advantageous. Examples or particular opening sizes include about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.5, 2.0, 2.5, 3.0, 3.5, and 4.0 mm, as well as any opening size or size range between any of these values. As will be appreciated, holes, pores, openings in mesh, and the like can also help to secure a dried reagent component to the reagent deposit zone of the substrate.

In some embodiments, the substrate 10, or portions thereof may be formed from a material which is compatible with biological material and/or molecules (e.g., biocompatible), such as cells or cellular components (e.g., nuclei, perinuclear compartments, nuclear membranes, mitochondria, chloroplasts, or cell membranes), proteins (e.g., antibodies, or membrane, trans-membrane or cytosolic proteins), oligonucleotides, lipids, polysaccharides, nucleic acids, viral particles, ribosomes, hormones, ions or cofactors.

In some embodiments, it may be beneficial for the substrate containing the dried (e.g., lyophilized) reagent to be attached to another device or cartridge to prevent movement after assembly during shipping and handling. As such, in some embodiments, a dried reagent:substrate complex can have an attachment layer (16 shown in FIGS. 13A and 13B) disposed on some or all of a surface of the substrate that is opposite that of the reagent deposit zone. In some embodiments, the attachment layer includes an adhesive or other bonding element that allows the dried reagent:substrate complex to be attached to a particular desired location, for example, on a surface of a particular location (e.g., in a specific reservoir, channel, reaction zone, detection zone, or the like) of a microfluidic molecular assay device. In some embodiments, the adhesive layer can be added to a side of the substrate opposite the side that will receive the liquid/dried reagent. In some embodiments, the adhesive layer can include pressure sensitive adhesives (PSAs), UV curable adhesives, cyanoacrylate adhesives, polymer-based adhesives (e.g., sugar), and/or thermally activated adhesives. In some embodiments, the adhesive layer can be applied to the substrate before a reagent is added to the other side of the substrate. In some embodiments, the adhesive layer can be applied to the substrate after a reagent has been added (e.g., after deposition, freezing, and/or lyophilization). In some embodiments, the substrate may be laminated to the adhesive layer (e.g., laminated to a pressure sensitive adhesive).

In some embodiments, once a liquid reagent aliquot is deposited on the surface 20 of a desired substrate, for example, on a reagent deposit zone 30, the surface (with the liquid reagent) can be treated under conditions to desiccate, at least partially or entirely, the aliquot and form a stable dried reagent:substrate complex. In some embodiments, after lyophilization, the lyophilized reagent anchored to the substrate (e.g., dried reagent:substrate complex) can be presented to automated assembly equipment for subsequent automated placement of one precut reagent:substrate complex in a cassette, cartridge, tube, etc. using traditional pick and place technology. In some embodiments, the dried reagent:substrate complex can be adhered to a device (e.g., cassette, cartridge, tube, etc.) by the adhesive layer on the side of the substrate opposite the lyophilized reagent. This can help prevent movement of the lyophilized reagent (and dried reagent:substrate complex) during any subsequent shipping and handling.

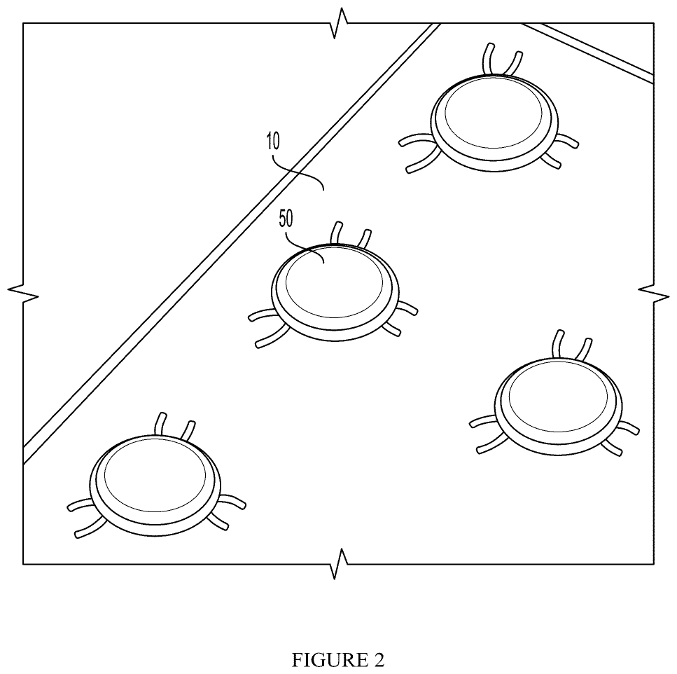

FIG. 2 shows a substrate 10 having formed dried reagent:substrate complexes 50 thereon. In some embodiments, once the surface of the substrate has been treated to form the dried reagent:substrate complex, the surface, including the dried reagent:substrate complex, may be covered with a substrate layer to package the substrate and dried reagent:substrate complex. For example, a flexible membrane, such as a thin polymeric film, may be utilized to cover the surface and/or dried reagent:substrate complex(es).

In addition to producing a dried reagent:substrate complex having a single type of reagent, the methodology disclosed herein provides for generating a dried reagent:substrate complex that includes at least two different types of reagents. Often times, more than one reagent may be required in a reaction (e.g., in an assay). However, the individual reagents themselves may react if they are in contact with each other. Thus, in some embodiments, the reagents can be physically separated such that they do not react until desired to react. The methods disclosed herein can allow for the lyophilization of multiple reagents in physical contact/communication with each other with little or no interaction during processing and subsequent storage after processing.

In some embodiments, to prevent mixing and/or reaction of liquid reagents during production of dried reagent:substrate complexes, one or more successive freeze cycles can performed as one type of liquid reagent is deposited on a different type of reagent. The resulting dried reagent:substrate complex includes distinct homogeneous layers of different reagents. For example, FIG. 15 illustrates first layer of reagent 13 and second layer of (different) reagent 14 on top of first layer of reagent.

In some embodiments, disclosed herein are methods of generating a dried reagent:substrate complex having at least two different reagents on a substrate. In some embodiments, the method can include: a) depositing a first liquid aliquot of a first reagent on a substrate having a surface for contacting the reagent, wherein the surface is treated to increase the hydrophilicity and/or anchoring of the dried reagent of the surface; b) freezing the first aliquot forming a first homogeneous frozen layer of the first reagent; c) depositing a second liquid aliquot of a second reagent on the first homogeneous frozen layer; d) freezing the second aliquot to form a reagent laminate having the first homogeneous frozen layer and a second homogeneous frozen layer of the second reagent; and e) treating the surface under conditions to lyophilize the laminate and form a solid phase, wherein the increased hydrophilicity and/or anchoring causes the laminate to form a shape having a reduced height dimension, thereby generating the dried reagent:substrate complex on the solid phase substrate.

It will be appreciated that utilizing successive freeze cycles as reagents are deposited, can generate a stable and dried reagent:substrate complex having any number of different (or same or similar) reagents disposed in homogeneous layers. In various embodiments, the dried reagent:substrate complex includes at least 2, 3, 4, 5, 6, 7, 8, 9, 10, or more homogeneous layers, wherein at least one layer has a different reagent than another layer. In some embodiments, the dried reagent:substrate complex includes at least 2, 3, 4, 5, 6, 7, 8, 9, 10, or more homogeneous layers, wherein at least one layer has the same reagent has another layer.

The dried reagent:substrate complex produced by the methods disclosed herein may include any reagent that can be dried from a liquid form and then reconstituted prior to use, for example in an assay. Examples include, but are not limited to, binding reagents useful in binding assays, enzymes, enzyme substrates, indicator dyes and other reactive compounds that may be used to detect an analyte of interest (i.e., target analyte), or combinations thereof. In some embodiments, the assay reagents may also include substances that are not directly involved in the mechanism of detection but play an auxiliary role in an assay including, but not limited to, blocking agents, stabilizing agents, reducing agents, oxidizing agents, chaotropic agents, detergents, salts, pH buffers, preservatives, diluents, excipients, or combinations thereof. In some embodiments, the reagents may also include biological cells or molecules including, but not limited to, cells, proteins (e.g., antibodies, and membrane, trans-membrane and cytosolic proteins), oligonucleotides, lipids, polysaccharides, nucleic acids, viral particles, ribosomes, antigens, hormones, ions, cofactors, or combinations thereof.

In some embodiments, the reagent includes a time release component that may alter the solubility of the reagent. In this manner, a dried reagent:substrate complex may be produced in which different layers reconstitute at different times when utilized in an assay. In some embodiments, a dried reagent:substrate complex includes at least one homogenous reagent layer that includes a time release component, such as a water soluble polymer or hydrogel.

In some embodiments where the substrate is flexible, it may be produced using a reel-to-reel manufacturing process. For example, the substrate may be formed by providing a stock reel for each layer type, e.g., solid phase substrate and optionally the coating substrate layer, and a final reel holding the formed substrate. In some embodiments, the reels can be rotated to transfer material from the stock reels and deposit the formed substrate on the final reel. In some embodiments, the substrate can pass through various stages as the substrate is passed between the reels. For example, the substrate or portions thereof can pass through a stage at a surface of the substrate is treated to increase hydrophilicity or subsequent anchoring of the dried lyophilized product and/or a stage which aliquots of liquid reagents are deposited on the substrate, advantageously on reagent deposit zones. In some embodiments, the substrate may then be subjected to different treating procedures to form the dried reagent:substrate complexes on the surface of the substrate.

In some embodiments, the substrate having one or more dried reagent:substrate complexes formed thereon may include a substrate layer disposed over the entire substrate, or over at least the dried reagent:substrate complexes to prevent contamination and/or degradation of the dried reagent:substrate complexes once formed. In some embodiments, the substrate layer may be a thin film that is peelable from the solid phase substrate.

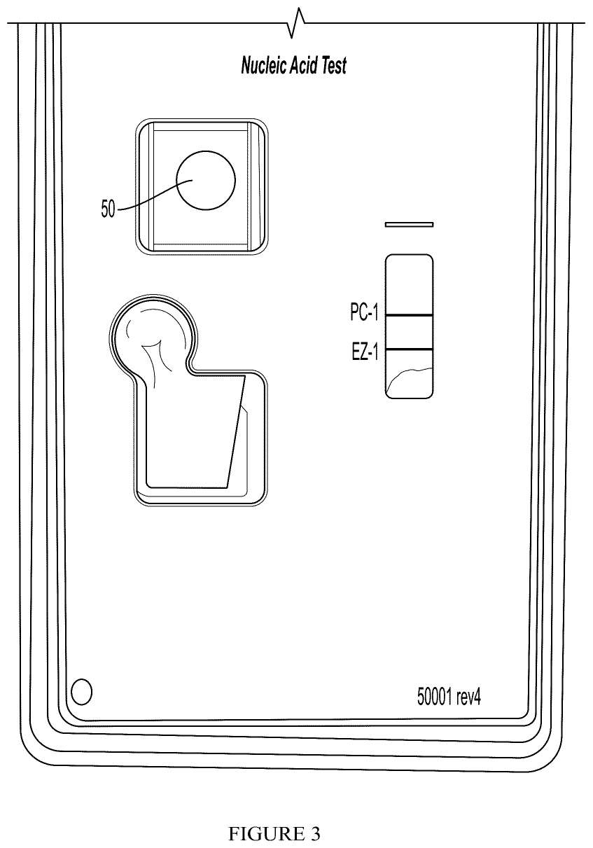

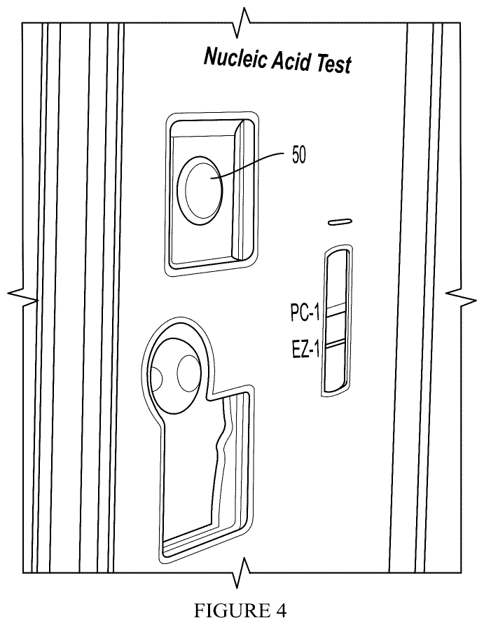

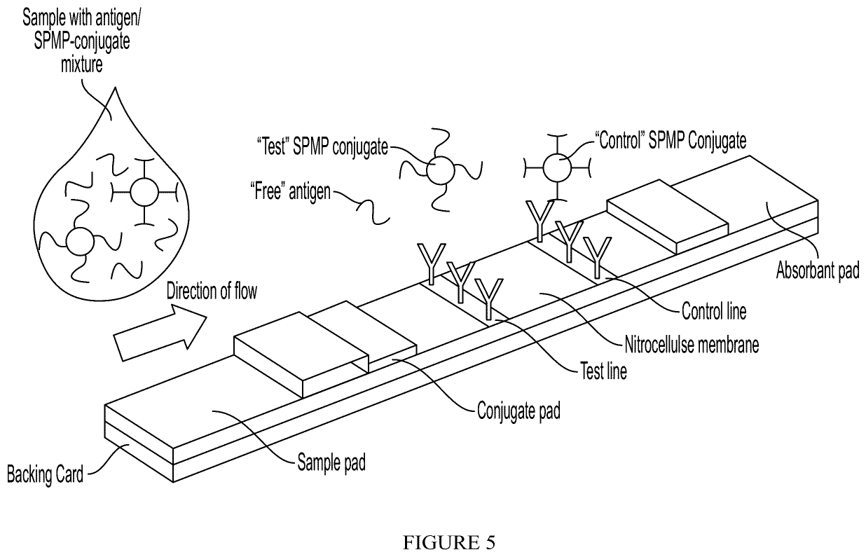

In embodiments, the substrate generated by the methods disclosed herein includes dried reagent:substrate complexes of different types of reagents disposed on different location of the surface which are configured to perform an assay on the substrate. For example, the substrate may be incorporated into an assay device as shown in FIGS. 3-5, such as a lateral flow assay device as shown in FIG. 5.

A typical lateral flow device is illustrated in FIG. 5. In some embodiments, typical lateral flow devices include a sample pad for receiving a liquid sample, and additional regions/zones downstream of the sample pad which may include for example, a conjugate pad, one or more zones including reagents and a detection zone. In some embodiments, a liquid sample is deposited on the sample pad and then flows downstream through the various regions. In some embodiments, disclosed herein is a lateral flow assay device which includes a substrate produced by the methods disclosed herein having one or more dried reagent:substrate complexes thereon. In some embodiments, the dried reagent:substrate complex may be disposed integral with or adjacent the sample pad such that liquid sample deposited on the sample pad rehydrates the dried reagent:substrate complex. In some embodiments, the reaction mixture of test sample and rehydrated reagent is then wicked downstream toward a detection zone and may involve rehydration of one or more additional dried reagent:substrate complexes as the reaction mixture flows downstream. Although a lateral flow device has been illustrated as shown in FIG. 5, it will be appreciated that a device is not limited to this specific lateral flow device but rather may be used in any conventional lateral flow device that includes a sample receiving pad. Illustrative examples of lateral flow assay devices which may incorporate the device as a sample pad include, but are not limited to those disclosed in U.S. Pat. Nos. 10,073,091, 9,989,527, 9,709,562, 8,846,319, 9,944,922, 9,915,657, 8,822,151, 8,580,572, 8,153,444, 7,858,396, 7,910,381, 7,537,937, 7,344,893, 6,924,153, 6,372,513 and 6,656,744, each of which is incorporated herein in their entirety by reference.

In some embodiments, a method of performing an assay is disclosed. In some embodiments, the method utilizes the substrate configured for immersing a portion of the substrate into a liquid test sample or depositing a liquid test sample onto the surface of the substrate, e.g., a lateral flow assay device shown in FIG. 3.

In some embodiments, the test sample may be a liquid, gas, or solid. Depending on the type of assay being performed and the type of sample being utilized, one in the art would appreciate that one or more excipients or diluents may be utilized with the test sample to facilitate rehydration of the dried reagent:substrate complex(s) and contact between the reagent(s) and the test sample.

Depending on the type of assay being conducted, a control system such as a computer or other automation device may be used to monitor and control the operation of the assay device and/or to analyze obtained data. In some embodiments, the solid phase substrate may include circuitry for controlling the assay and/or monitoring the assay and optionally be in operable connection to a control system. In some embodiments, the circuity is flexible so as to be used in a flexible substrate. In some embodiments, the circuitry is operable to heat, cool, or otherwise manipulate the reaction mixture within the chamber. For example, the circuitry may be operable to control a PCR reaction and/or a nucleic acid hybridization reaction.

In some embodiments, the assay device may include one or more channels to facilitate use in, or with, an automated system, such as a biological or chemical analyzer. The one or more channels may be provided in the substrate and provide a fluid pathway between dried reagent:substrate complexes and the automated system or analyzer for passage of a reaction mixture. Such channels may be microchannels to facilitate use with a microfluidics system. For example, in some embodiments, the substrate may include microchannels to allow fluid flow into and out of regions having dried reagent:substrate complexes for further analysis or manipulation of a reaction mixture by a microfluidics system.

The following examples are provided to further illustrate the advantages and features of the various methods, devices, components, and complexes described herein, but it is not intended to limit the scope of this disclosure. Although this example is typical of those that might be used, other procedures, methodologies, or techniques known to those skilled in the art may alternatively be used.

### EXAMPLE I

### Formation of Dried Reagent:Substrate Complexes on a Solid Phase Substrate

A solid phase substrate having dried reagent:substrate complexes was generated using the methodology as follows.

1X excipient solution was formulated that would typically be used in the lyophilization of a PCR master mix.

A 0.015″ polycarbonate film was plasma treated to render the surface hydrophilic. Note that if the film surface was not modified and a 4.7 uL drop of the excipient solution was applied to the surface, the solution would appear to be a spherical drop with a diameter of approximately 2.1 mm. However, when the surface is modified using plasma treatment, the same 4.7 uL drop appeared to be a slightly concave disc with a thickness of about 0.48 mm.

The polycarbonate film containing multiple liquid reagent dispenses was then placed on a precooled (−40C) shelf and allowed to freeze for approximately 15 minutes.

The discs were then lyophilized for approximately 22 hours.

The films containing the lyophilized discs were harvested by simply inverting the film and collecting the lyophilized discs in bulk. In another embodiment the film could be modified such that the discs are retained on the surface of the film. Note that the lyophilized discs were approximately 4 mm in diameter with a thickness of approximately 0.48 mm.

The lyophilization procedure was optimized and repeated and dried reagent discs were formed using a lyophilization time of less than 1 or 2 hours.

### EXAMPLE 2

### LyoDots™—Another Lyophilization Format having Freeze-Dried Reagent:Substrate Complexes on a Solid Phase Substrate

This Example 2 demonstrates a new configuration of lyophilized material where a lyophilized reagent is prepared in the form of a flat, circular, dome shape called a LyoDot™ (Argonaut Manufacturing Services, Carlsbad, CA). This reagent configuration accommodates small spaces and allows for rapid dissolution/resuspension of the lyophilized material, which can be important criteria when designing and manufacturing a shallow-depth chambers are found in many microfluidic diagnostic devices.

To create a LyoDot, a liquid reagent is applied to a substrate, e.g., a film or mesh, having a surface treated to enhance its hydrophilicity and/or subsequent anchoring of the reagent and subsequently lyophilized. The substrate can provide mechanical support, and the underside of the substrate allows, for example, adhesive application of one or more LyoDots to be attached to one or more specific locations in a microfluidic device, it being understood that the surface of LyoDot substrate opposite to that on which the liquid reagent was dispensed.

LyoDots can be easily integrated into device assemblies using any suitable approach, for example, standard “pick and place” automation due to their robust nature and planar X-Y coordinate (Cartesian) layout. As a proof of principle, and as described in this Example, LyoDots were created using RT-qPCR assay reagents from Fortis Life Sciences and multiplexed oligonucleotides corresponding to the CDC 2019 nCoV RT PCR assay. The LyoDots had a diameter of 3.75 mm and a thickness of 390 μm. When the LyoDots were functionally tested, assays resulting from their use were found to produce results that were comparable to results obtained using the liquid reagents prior to lyophilization.

To further highlight utilization of LyoDots in diagnostic device applications, this Example also describes the results obtained from using two LyoDots, each containing a different dye, after placing them in a chamber that was 0.5×0.5×0.030 inches. The LyoDots were placed adjacent to each other and were attached to the surface via adhesive, which was applied to the underside of a clear film substrate. Upon exposure to liquid, the LyoDots readily reconstituted and the resulting solutions remained on their respective side of the chamber. These dye-containing LyoDots exhibited attributes of fast dissolution and the ability to maintain spatial control of reconstituted lyophilized material, highlighting the attractiveness of using LyoDots in microfluidic devices or small point-of-care tests, which are rapidly growing segments in the molecular diagnostics market.

This Example, which demonstrates LyoDot functionality and implementation in a microfluidic device, shows the applicability of LyoDots to many types of microfluidic devices. Furthermore, this Example shows that LyoDots enable high volume, cost effective, “automation friendly” formats required for present and future generations of point-of-care testing equipment and methods.

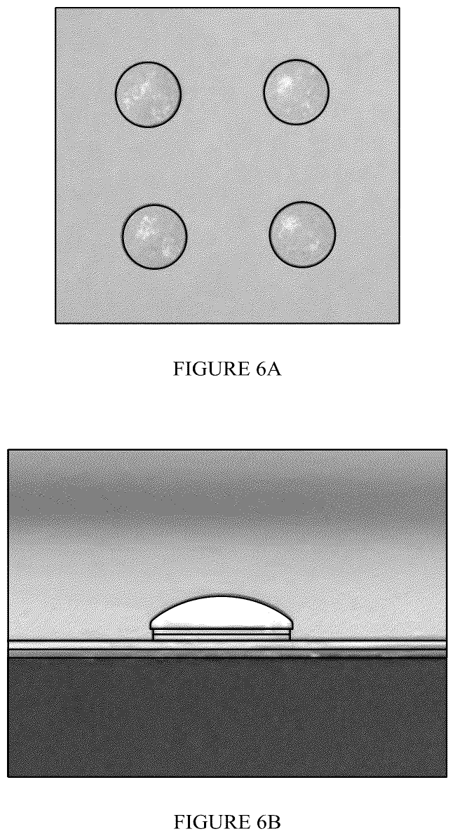

The COVID-19 pandemic highlighted the need for rapid and sensitive diagnostic tests that are stable at room temperature and can be easily transported. One way to achieve this is through the incorporation of lyophilized reagents. A variety of lyophilization formats are known. For example, LyoDose™ bead technology (Argonaut Manufacturing Services, Carlsbad, CA), which consists of a sphere with lyophilized reagents in amounts needed for a single reaction in a device or well, has been utilized by many companies to enhance their products. Although the spherical shape of a LyoDose™ bead is compatible with many devices, the desire to reduce device footprint requires a thinner lyophilized material geometry. This Example describes a new configuration of lyophilized material where the lyophilized reagent is in the form of a circular, dome-shape called a LyoDot™ (FIG. 6).

A significant advantage of the LyoDot configuration is that it can allow a similar amount of lyophilized material to fit into thinner spaces as compared to conventional, bead-shaped lyophilized reagents (e.g., LyoDose beads) that contain comparable amounts of lyophilized material. For example, a LyoDot made from a 5 μL aliquot of liquid reagent (before lyophilization) was more than five times thinner than a spherical bead made with the same volume of liquid reagent. In general, a LyoDot is created by applying a liquid reagent to the surface of a substrate such as a thin film or mesh that has been treated to increase the hydrophilicity and/or subsequent anchoring of the reagent of the surface to which the liquid reagent is applied, followed by lyophilization. The substrate provides mechanical support, and the surface of the substrate opposite that to which the liquid reagent is applied can be used for adhesive application, which adhesive can then be used to attach the substrate to a specific location in a diagnostic device (e.g., a microfluidic device configured to perform a molecular diagnostic assay such as an immunoassay, a nucleic acid-based pathogen detection assay, etc.). As will be appreciated, surface-modified substrates upon which liquid reagents are lyophilized, such as LyoDots, can be easily integrated into diagnostic devices during assembly using standard “pick and place” automation due to their robust nature and planar X-Y coordinate layouts. These attributes will further enhance device miniaturization while also lowering reagent and diagnostic device manufacturing cost.

A representative example of LyoDot technology involved the preparation of material to perform a CDC 2019-nCoV RT-PCR assay. Here, LyoDots containing RT-qPCR master mix (Empirical Bioscience, Inc.) to perform an RT-qPCR assay (N1 assay=FAM, N2 assay=HEX, RNase P assay=ROX) combined with multiplexed oligonucleotides were prepared. These LyoDots had a diameter of 3.75 mm and a thickness of 390 μm (see FIG. 6). Synthetic SARS-CoV-2 RNA template (Twist Bioscience) was added to the RT-qPCR reactions (20 uL final volume per reaction) at 5×10⁵, 5×10⁴, 5×10³, 5×10², 5×10¹, or 0 (negative control) copies. To simulate a clinical sample, Universal Human Reference RNA remained constant at 1 ng per reaction for each condition. LyoDots were resuspended in molecular grade water at 15 μL of water per one LyoDot, and the resulting suspension was distributed to qPCR plates at 15 μL volumes per well. Then, template (5 uL/reaction) was added to the wells, followed by RT-qPCR. Non-lyophilized liquid reagents were also tested. Samples were tested in triplicate for each condition.

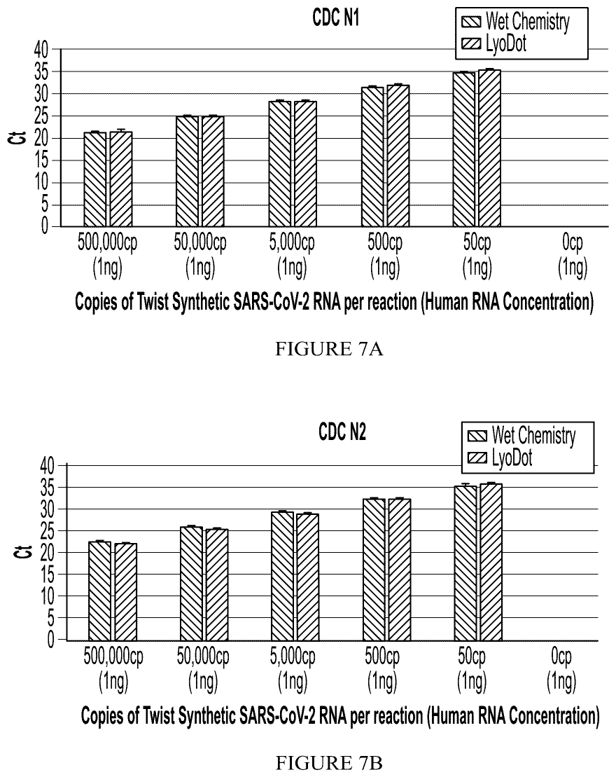

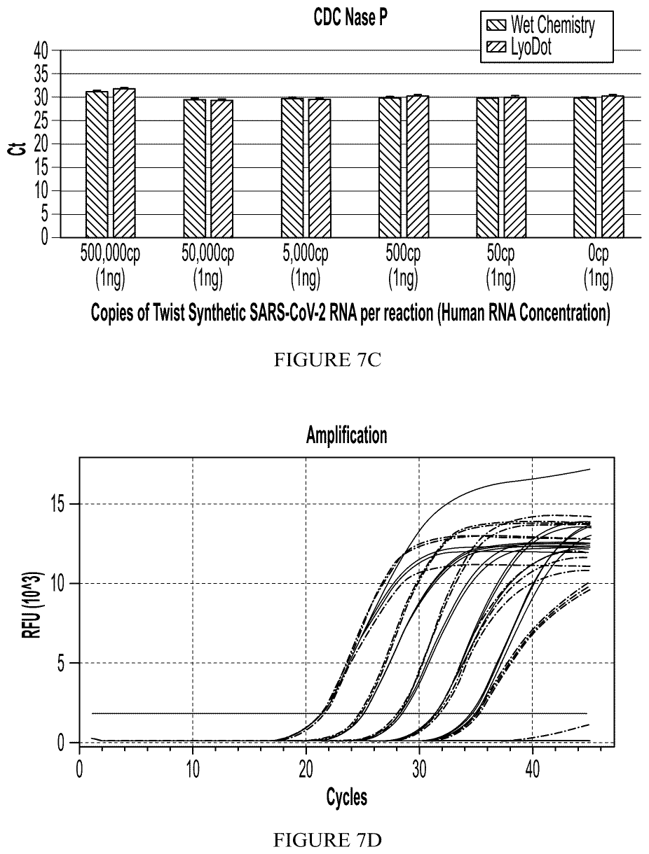

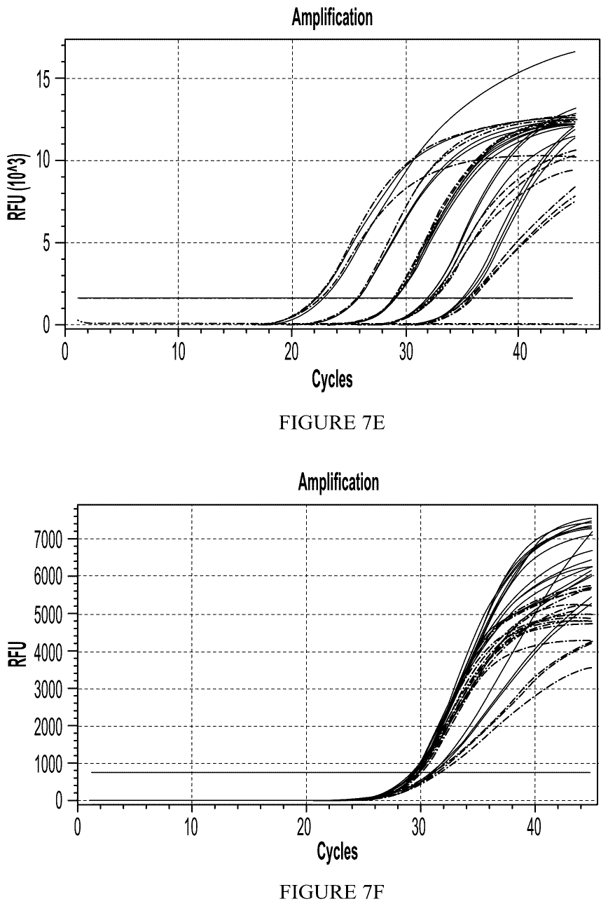

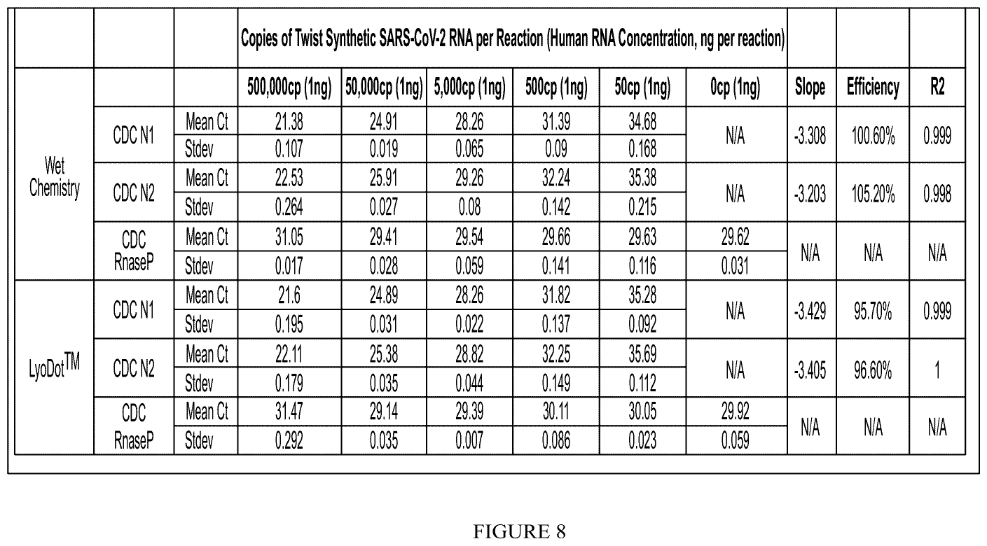

The results of this RT-qPCR testing are shown in FIGS. 7 and 8. FIG. 7 shows six panels, (A)-(F), representing RT-qPCR results from experiments described in Example 2, below, which involved a CDC 2019-nCoV RT-PCR assay using LyoDot material (hatched lines in FIGS. 7D-7F) compared to the non-lyophilized liquid reagents (solid lines in FIGS. 7D-7F). In these experiments, synthetic SARS-CoV-2 RNA copy number was varied, while the concentration of RNase P template was held constant at 1 ng per reaction. Each sample was run in triplicate. Bar charts of the Ct values for the CDC 2019-nCoV RT-PCR N1 (A) and CDC 2019-nCoV RT-PCR N2 (B) assays at different copy numbers are shown. A bar chart of the Ct values for the RNase P template (C) at a constant copy number with variable amounts of SARS-CoV-2 RNA is presented. The corresponding amplification curves for the CDC 2019-nCoV RT-PCR N1 (D), CDC 2019-nCoV RT-PCR (E), and CDC 2019-nCoV RT-PCR RNase P (F) assays are also shown.

The resuspended LyoDot material demonstrated similar dynamic range and sensitivity when compared to the non-lyophilized liquid reagents. Negative controls (no nCoV template and with Universal Human Reference RNA) demonstrated amplification for RNase P while N1 and N2 had no detectable amplification. The CDC 2019-nCoV RT-PCR N1 and N2 assays displayed nearly 100% PCR reaction efficiency for both sets of reagents (lyophilized and liquid), with nearly identical Ct values. The CDC 2019-nCoV RT-PCR RNase P assay Ct values remained similar throughout the experiment, except when the copy number of nCoV synthetic RNA was at 500,000 copies per reaction, in which case RNase P was 2 Ct higher. This higher Ct was found in both non-lyophilized liquid reagents and LyoDots and was likely due to reagent component (e.g., oligonucleotides, dNTPs) depletion during amplifying the high copy RNA (here, the N1 and N2 targets), which led to less efficient amplification of the lower copy RNase P target. Overall, these results demonstrate equivalent performance of biochemical assays (here, RT-qPCR assays) using LyoDots and the non-lyophilized liquid reagents.

### EXAMPLE 3

### Use of LyoDots™ in a Microfluidic Device

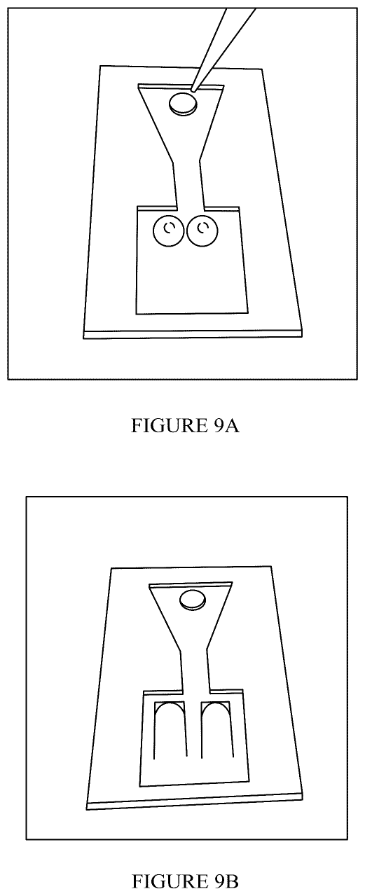

To illustrate the use of the lyophilized reagent format in a microfluidic device, LyoDots (see Example 2, above) containing different dyes were prepared and then incorporated into an acrylic microfluidic chamber with dimensions of 0.5×0.5×0.030 inches (FIG. 9A). LyoDots were adhered to the surface of the chamber by placing adhesive on the underside of the surface-modified substrate used to prepare the LyoDots so as to prevent their movement when placed in the microfluidic device. After water was introduced to the device, the LyoDot components readily dissolved and remained on their respective sides of the chamber (FIG. 9B), demonstrating spatial control of the dissolved lyophilized material. This experiment demonstrates that LyoDots can be used in devices with shallow chambers where efficient storage, dissolution, and transfer of reagents are needed. As is known, such microfluidics devices include those used to perform immunoassays and molecular assays.

### EXAMPLE 4

### LyoDot™ Handling

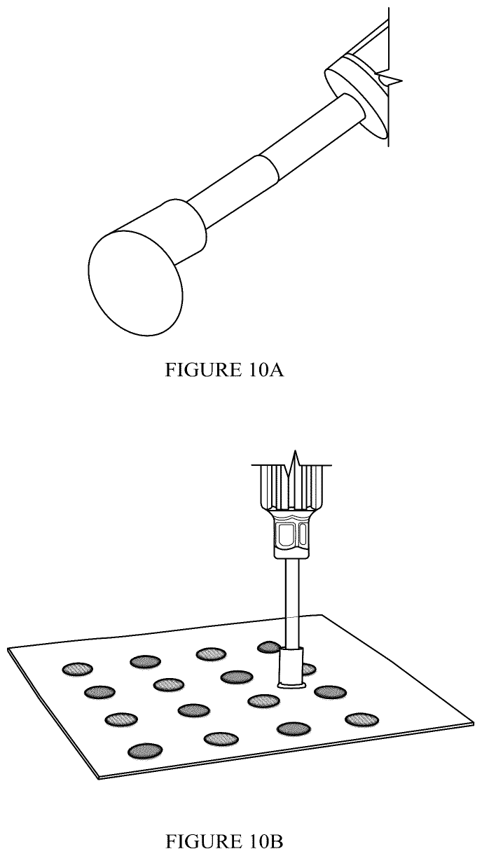

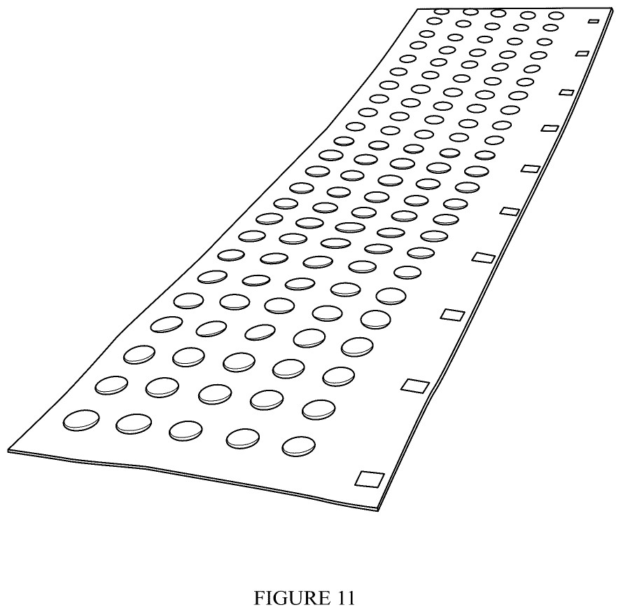

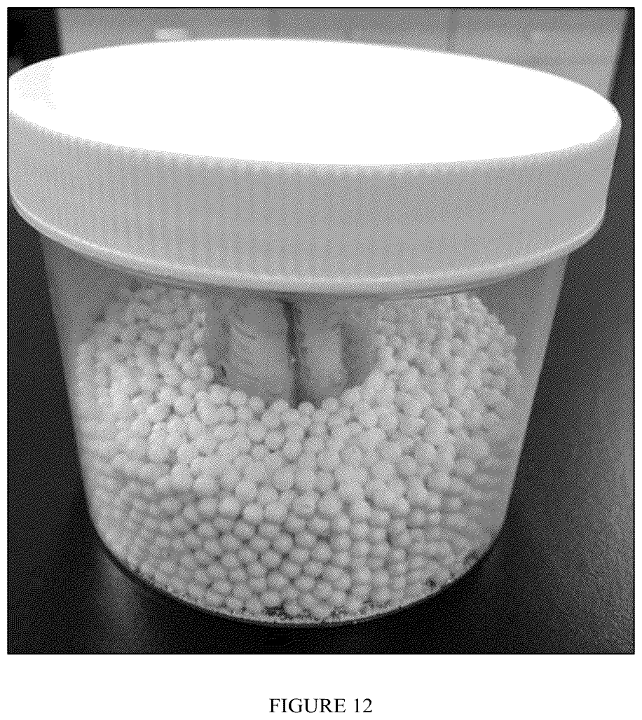

An important manufacturing consideration is robustness in handling, as occurs, for example, during the manufacture of microfluidic devices. This Example demonstrates that the lyophilized reagent format is compatible with conventional “pick and place” handling techniques that use “air tweezers” to move and manipulate components of microfluidic diagnostic devices during the assembly of such devices (see, e.g., FIG. 10, A). For adaptability with high-throughput manufacturing methods, the lyophilized reagent format (e.g., LyoDots) can also be configured into sheets (FIG. 10B and FIG. 11).

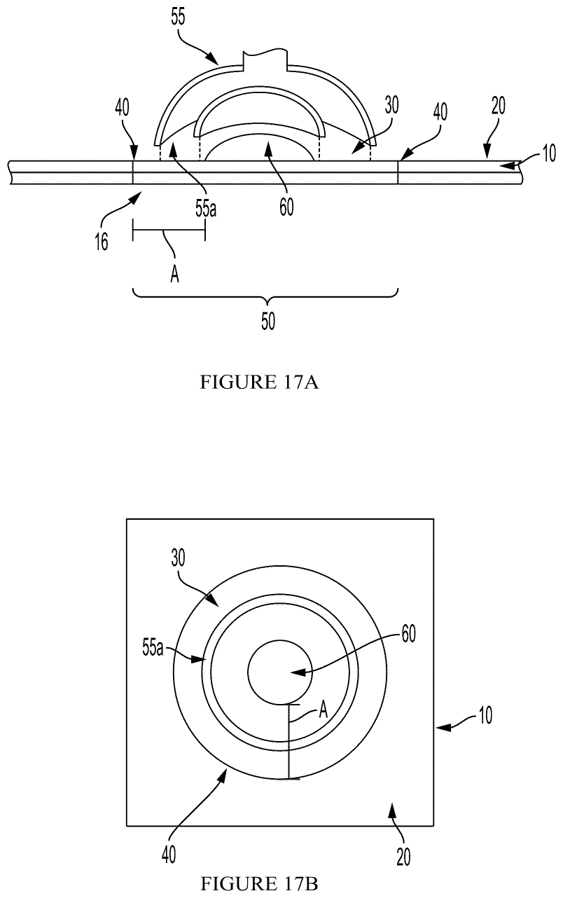

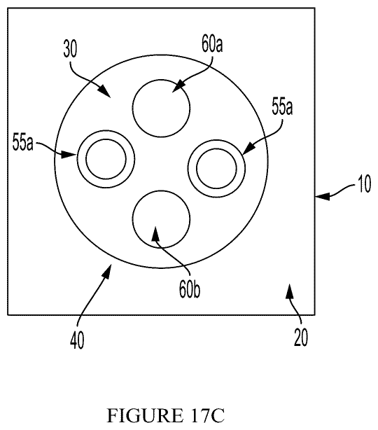

In some embodiments, the dried reagent:substrate complex can be removed from the rest of the substrate via automation (i.e., robotic removal). In some embodiments, the dried reagent:substrate complex can be removed via a removal tool or tools 55 (e.g., an air tweezer) as shown in FIGS. 17A and 17B. FIGS. 17A and 17B illustrate examples of a cross-sectional side (17A) and top (17B) view of the removal of a dried reagent:substrate complex in accordance with some embodiments disclosed herein. In some embodiments, the removal tool(s) 55 can operate by using a vacuum to pick up the dried reagent:substrate complex 50. As explained above, the dried reagent:substrate complex 50 can include the dried reagent 60 anchored to the reagent deposit zone 30 of the top surface 20 of the substrate 10 and an attachment layer 16 on the side of the reagent deposit zone 30 opposite the dried reagent 60. In addition, as previously explained, the reagent deposit zone 30 can be defined by recessed region, cut-out, or kiss cut 40.

In some embodiments, the removal tool can remove the dried reagent:substrate complex without contacting the dried reagent, thereby minimizing the potential for damage to the dried reagent. In some embodiments, the removal tool can include at least one suction tip 55a that can attach to a portion of the reagent deposit zone 30. In some embodiments, the at least one suction tip 55a can attach to a portion of the reagent deposit zone 30 in a region A between the perimeter of the dried reagent 60 and the edge or perimeter of the recessed region, cut-out, or kiss cut 40. In some embodiments, the removal tool utilizes a vacuum to create suction at the tip(s) of the removal tool to allow the removal tool to pick up the dried reagent:substrate complex 50 and remove it from the rest of the substrate 10. In some embodiments, the removal tool's tip(s) can surround the dried reagent 60 without making contact with any portion of the dried reagent similar to a dome covering the dried reagent 60. In some embodiments, the removal tool's tip or tips can attach to an area of the reagent deposit zone that does not include a dried reagent. For example, FIG. 17C illustrates a cross-sectional top view of the removal of a dried reagent:substrate complex that includes two dried reagents 60a and 60b. As shown, suction tips 105a can attach to a portion of the reagent deposit zone 30 between the area of the dried reagents 60a and 60b and the edge or perimeter of the recessed region, cut-out, or kiss cut 40.

In some embodiments, the recessed region, cut-out, or kiss cut 40 can allow for an easier removal of the dried reagent:substrate complex from the rest of the substrate. As previously explained, after removal of the dried reagent:substrate complex, it can be placed at a variety of locations including in an assay device.

### DEFINITIONS

For the purpose of clarity and a concise description, features are described herein as part of the same or separate embodiments and/or examples; however, it will be appreciated that the scope of the disclosure includes embodiments and/or examples having combinations of all or some of the features described.

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Reference to “about” a value or parameter herein includes (and describes) variations that are directed to that value or parameter per se. For example, description referring to “about X” includes description of “X”. In addition, reference to phrases “less than”, “greater than”, “at most”, “at least”, “less than or equal to”, “greater than or equal to”, or other similar phrases followed by a string of values or parameters is meant to apply the phrase to each value or parameter in the string of values or parameters.

As used herein, the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

This application discloses several numerical ranges in the text and figures. The numerical ranges disclosed inherently support any range or value within the disclosed numerical ranges, including the endpoints, even though a precise range limitation is not stated verbatim in the specification because this disclosure can be practiced throughout the disclosed numerical ranges.

The above description is presented to enable a person skilled in the art to make and use the disclosure, and is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein.

What is claimed is:

1. A method comprising:
applying an adhesive layer to a side of a substrate;
plasma treating a side of the substrate opposite the adhesive layer;
depositing an aliquot of a liquid reagent on the plasma treated side of the substrate such that the contact angle of the liquid reagent and the plasma treated side of the substrate is less than 50 degrees;
freezing the aliquot of the liquid reagent on the plasma treated side of the substrate;
lyophilizing the frozen aliquot of the reagent, thereby generating a dried reagent:substrate complex comprising a dried reagent anchored to the plasma treated side of the substrate and the adhesive layer on the side of the substrate opposite the dried reagent.

2. The method of claim 1, wherein the plasma treating comprises atmospheric plasma treatment.

3. The method of claim 2, wherein the atmospheric plasma treatment is at a rate of 5-15 mm/s.

4. The method of claim 1, wherein the adhesive layer comprises a pressure sensitive adhesive, a UV curable adhesive, a cyanoacrylate adhesive, a polymer-based adhesives, or a thermally activated adhesive.

5. The method of claim 1, wherein applying the adhesive layer to the substrate comprises laminating a pressure sensitive adhesive to the substrate.

6. The method of claim 1, further comprising cutting partially or entirely through the substrate in a predefined shape or pattern to define a reagent deposit zone on the substrate.

7. The method of claim 6, wherein cutting partially or entirely through the substrate comprises laser, die, water jet, or plotter cutting.

8. The method of claim 6, wherein the reagent deposit zone is attached to a portion of the substrate outside of the reagent deposit zone by one or more attachment points.

9. The method of claim 6, wherein the reagent deposit zone is plasma treated.

10. The method of claim 6, wherein the aliquot of liquid reagent is deposited on the reagent deposit zone.

11. The method of claim 10, further comprising removing the dried reagent:substrate complex from the portion of the substrate outside the reagent deposit zone.

12. The method of claim 11, wherein removing the dried reagent:substrate complex comprises surrounding the dried reagent of the dried reagent:substrate complex with removal tool comprising a suction tip.

13. The method of claim 12, wherein the suction tip attaches to a portion of the reagent deposit zone in a region between a perimeter of the reagent deposit zone and a perimeter of the dried reagent.

14. The method of claim 12, wherein the removal tool does not contact the dried reagent during removal of the dried reagent:substrate complex.

15. The method of claim 1, further comprising adding the dried reagent:substrate complex to an assay device.

16. The method of claim 1, further comprising contacting the dried reagent:substrate complex with a test sample to produce a reaction mixture.

17. The method of claim 16, further comprising detecting a target analyte in the reaction mixture if the target analyte is present in the test sample.

18. The method of claim 1, further comprising depositing a second aliquot of a second liquid reagent on the frozen aliquot of the first liquid reagent.

19. The method of claim 18, further comprising freezing the second aliquot on the first frozen aliquot and lyophilizing the first and second frozen aliquots, thereby generating a dried reagent:substrate complex comprising a first dried reagent anchored to the plasma treated side of the substrate, an adhesive layer on the side of the substrate opposite the first dried reagent, and a second dried reagent on a side of the first dried reagent opposite the substrate.

20. The method of claim 1, wherein the substrate has a thickness of about 0.001-0.01 inches.

21. The method of claim 1, wherein the lyophilization step takes less than 1 hour.

22. The method of claim 1, further comprising adding micro-structures in and/or on the side of the substrate opposite the adhesive layer.

23. The method of claim 22, wherein the micro-structures are formed by debossing, vacuum forming, injection molding, photolithography, or embossing.

24. The method of claim 1, wherein the dried reagent has a maximum height and an outer diameter, wherein the maximum height is equal to or less than 50% of the outer diameter.

25. The method of claim 1, wherein the dried reagent is anchored to the plasma treated side of the substrate such that it takes at least about 50 g of force to dislodge the dried reagent from the substrate as measured by sheer testing.
